(19) United States
(12) Patent Application Publication
(10) Pub. No.: US 2011/0188008 A1
(43) Pub. Date: Aug. 4, 2011

(54) PROJECTION DISPLAY APPARATUS

(75) Inventors: Makoto MAEDA, Osaka-City (JP); Masafumi TANAKA, Hirakata-City (JP); Ken MASHlTANI, Neyagawa-city (JP)

(73) Assignee: SANYO ELECTRIC CO., LTD., Osaka (JP)

(21) Appl. No.: 13/016,806

(22) Filed: Jan. 28, 2011

(30) Foreign Application Priority Data
Jan. 29, 2010 (JP) 2010-017889
Jan. 29, 2010 (JP) 2010-019783
Feb. 26, 2010 (JP) 2010-042546

(51) Int. Cl. G03B 21/14

(52) U.S. Cl. 353/85

(57) ABSTRACT

A projection display apparatus for projecting an image light onto a projection plane, includes: a detector configured to detect a state of the projection display apparatus with respect to the projection plane; and a controller configured to control a state of the image light according to the detected state.

### CROSS REFERENCE TO RELATED APPLICATIONS

This application is based upon and claims the benefit of priority from prior Japanese Patent Application No. 2010-17889, filed on Jan. 29, 2010; prior Japanese Patent Application No. 2010-19783, filed on Jan. 29, 2010; and prior Japanese Patent Application No. 2010-42546, filed on Feb. 26, 2010; the entire contents of which are incorporated herein by reference.

### BACKGROUND OF THE INVENTION

1. Field of the Invention

The present invention relates to a small-sized projection display apparatus, more particularly, to a projection display apparatus in a size of PET bottle, which is placed on a desk and uses the surface of the desk as a screen.

2. Background Art

Conventionally, a projection display apparatus (projector) which projects an image onto a screen, a wall surface or the like has been generally used. On the other hand, recently, a projector which is placed on e.g., a desk and projects an image onto the surface of the desk has been proposed. However, in this case, the distance between the emitting position of the projection light and the projection plane (the surface of the desk) becomes shorter, the projection optics needs to be devised, compared with the projector which projects an image onto a screen or a wall surface.

For example, Japanese Patent Application Publication No. 2003-280089 discloses a technology which shortens the distance between the emitting position of the projection light and the projection plane by bending the optical path of the projection light using multiple plane mirrors. Also, Japanese Patent Application Publication No. 2008-134350 and Japanese Patent Application Publication No. 2004-258620 disclose a technology which shortens the distance between the emitting position of the projection light and the projection plane by using a convex mirror and a concave mirror as the last optical member of a projection optics including mirrors.

However, for a small-sized projection display apparatus, not only a case where a single user observes an image projected onto the surface of a desk but also various application cases are expected, including a case where multiple users observe an image projected onto a conference desk, a case where an image is projected onto a wall surface from a projection display apparatus laid on a floor, and a case where an image is projected onto a wall surface from a ceiling-hung projection display apparatus. For example, as shown in FIGS. 17A and 17C as examples of the application cases, the image may be reversed upside down between the two cases where a single user observes an image projected onto a desk, and where the user observes an image projected onto a wall surface from a projection display apparatus laid on a floor.

### SUMMARY OF THE INVENTION

A first aspect of a projection display apparatus (projection display apparatus 100) projects an image light onto a projection plane. The projection display apparatus includes: a detector (tilt sensor 269, for example) configured to detect a state of the projection display apparatus with respect to the projection plane; and a controller (controller 160) configured to control a state of the image light according to the detected state.

According to the first aspect, the projection display apparatus determines the state of the projection display apparatus, and projects the image so that viewers may easily view the image, convenience of users can be improved.

In the first aspect, the detector is an installation surface detector (tilt sensor 269) configured to detect an installation state of the projection display apparatus. The controller controls a direction of the image light according to the installation state.

In the first aspect, the detector detects a first mode in which an approximately horizontal plane (XY plane) is the projection plane, and a second mode in which an approximately vertical plane (XZ plane) is the projection plane. The controller reverses the image light upside down (Far side is upside or Near side is downside, for example) according to the first mode and the second mode.

In the first aspect, the detector detects a first mode in which an approximately horizontal plane is the projection plane, and a second mode in which an approximately vertical plane is the projection plane. The controller controls an aspect ratio (landscape image or portrait image, for example) of the image light according to the first mode and the second mode.

In the first aspect, the detector is a projection distance detector (leg sensor 208s, for example) configured to detect a projection distance from the projection display apparatus. The controller controls a brightness of the image light according to the projection distance.

A second aspect of a projection display apparatus includes an imager (DMD 1070) configured to modulate light emitted from a light source; and a projection optics (projection optics 1110) configured to project light emitted from the imager onto a projection plane. The projection display apparatus includes; a storage unit (storage unit 1310) configured to store information which associates a specific region provided on the projection plane with processing detail to be performed by the projection display apparatus, a detection unit (detection unit 1320) configured to detect an object blocking light in the specific region; and an instruction unit (instruction unit 1330) configured to instruct an execution of the processing detail associated with the specific region when an object blocking light is detected for a predetermined time period or longer in the specific region.

In the second aspect, the specific region is a boundary region between an inside and an outside of a projection region where light emitted from the projection optics is projected.

In the second aspect, the storage unit stores information which associates a moving pattern of an object blocking light in the specific region with the processing detail. An object blocking light is detected with the moving pattern in the specific region, the instruction unit instructs an execution of the processing detail associated with the moving pattern.

In the second aspect, the projection display apparatus further includes a specific light source (specific light source 1410) configured to emit specific light to the specific region. The specific region is provided outside a projection region where light emitted from the projection optics is projected. The detection unit detects an object blocking light emitted from the specific light source in the specific region.

In the second aspect, the specific light source is configured to emit a plurality of types of specific light. The storage unit stores information which associates the processing detail with a combination of one or more types of specific light which is possibly blocked by the object in the specific region out of the plurality of types of specific light. The instruction unit instructs an execution of the processing detail associated with a combination of the one or more types of specific light which is blocked by the object in the specific region.

A third aspect of a projection display apparatus includes an imager (DMD 2070) configured to modulate light emitted from a light source (light source 2010); and a projection optics (projection optics 2110) configured to project light emitted from the imager onto a projection plane provided on a horizontal plane. The projection display apparatus includes a device controller (device controller 2320) configured to control the imager in such a manner that at least a first image frame and a second image frame are displayed on the projection region. The device controller is configured to be able to change orientations of the first image frame and the second image frame.

In the third aspect, the second image frame is an image frame on which an image to be viewed by an operator of the projection display apparatus is displayed.

In the third aspect, the device controller controls the imager in such a manner as to display an image, which is selected on the second image frame, on the first image frame in synchronization the image selected on the second image frame.

In the third aspect, the device controller controls the imager in such a manner as to switch the second image frame to the first image frame and display an image selected on the second image frame, on the first image frame.

In the third aspect, the device controller controls the imager in such a manner as to display a list of images stored in an external storage medium, on the second image frame in a case where the external storage medium is connected to the projection display apparatus when the projection display apparatus is turned on.

In the third aspect, the projection display apparatus further includes a power switch configured to be able to identify a position of an operator of the projection display apparatus. The device controller controls orientation of an image displayed on the second image frame according to the position of the operator identified by the power switch.

In the third aspect, when a power supply of the projection display apparatus is turned off and then turned on, the device controller controls the imager in such a manner as to display an image as the power supply is turned on, in a position of the image being displayed when the power supply is turned off.

### BRIEF DESCRIPTION OF THE DRAWINGS

FIG. 1 is a front view showing the configuration of a projection display apparatus according to a first embodiment.

FIG. 2 is a side view showing the configuration of the projection display apparatus according to the first embodiment;

FIGS. 3A and 3B are perspective views showing the external configuration of the projection display apparatus according to the first embodiment;

FIG. 4 is a diagram showing the internal configuration of the projection display apparatus according to the first embodiment when the projection display apparatus projects image light;

FIG. 5 is a diagram showing the internal configuration of the projection display apparatus according to the first embodiment when the projection display apparatus is retracted;

FIG. 6 is a diagram showing the internal configuration of a projection display apparatus according to Modification 1 of the first embodiment when the projection display apparatus projects image light;

FIG. 7 is a diagram showing the internal configuration of the projection display apparatus according to Modification 1 of the first embodiment when the projection display apparatus is retracted;

FIG. 8 is a diagram showing the internal configuration of a projection display apparatus according to Modification 2 of the first embodiment when the projection display apparatus projects image light;

FIG. 9 is a diagram showing the internal configuration of the projection display apparatus according to Modification 2 of the first embodiment when the projection display apparatus is retracted;

FIG. 10 is a diagram showing the internal configuration of a projection display apparatus according to Modification 3 of the first embodiment when the projection display apparatus projects image light;

FIG. 11 is a diagram showing the internal configuration of a projection display apparatus according to Modification 3 of the first embodiment when the projection display apparatus is retracted;

FIG. 12 is a front view showing the configuration of a projection display apparatus according to a second embodiment;

FIGS. 13A and 13B are diagrams for explaining projection modes of the projection display apparatus according to the second embodiment;

FIGS. 14A and 14B are diagrams for explaining projection modes of a projection display apparatus according to Modification 1 of the second embodiment;

FIGS. 15A and 15B are diagrams for explaining projection modes of a projection display apparatus according to Modification 2 of the second embodiment;

FIG. 16 is a diagram for explaining the projection mode of a projection display apparatus according to Modification 3 of the second embodiment;

FIGS. 17A to 17D are diagrams showing examples of use of a projection display apparatus according to the present invention;

FIG. 18 is a diagram showing a schematic configuration of a projection display apparatus 1100 according to a third embodiment;

FIG. 19 is a diagram showing a schematic configuration of the projection display apparatus 1100 according to the third embodiment;

FIG. 20 is a diagram showing the optical configuration of the projection display apparatus 1100 according to the third embodiment;

FIG. 21 is a diagram for explaining the sliding of a first housing 1200A according to the third embodiment;

FIG. 22 is a diagram for explaining the sliding of the first housing 1200A according to the third embodiment;

FIG. 23 is a block diagram showing a control unit 1300 according to the third embodiment;

FIG. 24 is a diagram for explaining an execution example of processing detail according to the third embodiment;

FIG. 25 is a diagram for explaining an execution example of processing detail according to the third embodiment;

FIG. 26 is a diagram for explaining an execution example of processing detail according to Modification 1;

FIG. 27 is a diagram for explaining an execution example of processing detail according to Modification 1;

FIG. 28 is a diagram for explaining an execution example of processing detail according to Modification 1;

FIG. 29 is a diagram for explaining an execution example of processing detail according to Modification 1;

FIG. 30 is a diagram for explaining a specific light source 1410 according to Modification 2;

FIG. 31 is a diagram for explaining a specific light source 1410 according to Modification 3;

FIG. 32 is a diagram for explaining an execution example of processing detail according to Modification 3;

FIG. 33 is a diagram showing a schematic configuration of a projection display apparatus 2100 according to a fourth embodiment;

FIG. 34 is a diagram showing a schematic configuration of the projection display apparatus 2100 according to the fourth embodiment;

FIG. 35 is a diagram showing the optical configuration of the projection display apparatus 2100 according to the fourth embodiment;

FIG. 36 is a diagram for explaining the sliding unit of a first housing 2200A according to the fourth embodiment;

FIG. 37 is a diagram for explaining the sliding unit of the first housing 2200A according to the fourth embodiment;

FIG. 38 is a block diagram showing a control unit 2300 according to the fourth embodiment;

FIG. 39 is a diagram for explaining a first display example according to the fourth embodiment;

FIG. 40 is a diagram for explaining the first display example according to the fourth embodiment;

FIG. 41 is a diagram for explaining the first display example according to the fourth embodiment;

FIG. 42 is a diagram for explaining the first display example according to the fourth embodiment;

FIG. 43 is a diagram for explaining a second display example according to the fourth embodiment.

FIG. 44 is a diagram for explaining the second display example according to the fourth embodiment;

FIG. 45 is a diagram for explaining the second display example according to the fourth embodiment;

FIG. 46 is a diagram for explaining the second display example according to the fourth embodiment;

FIG. 47 is a diagram for explaining the second display example according to the fourth embodiment;

FIG. 48 is a diagram for explaining the second display example according to the fourth embodiment;

FIG. 49 is a diagram for explaining the second display example according to the fourth embodiment;

FIG. 50 is a diagram for explaining the second display example according to the fourth embodiment;

FIG. 51 is a diagram for explaining a third display example according to the fourth embodiment;

FIG. 52 is a diagram for explaining a fourth display example according to the fourth embodiment;

FIG. 53 is a diagram for explaining the fourth display example according to the fourth embodiment; and

FIG. 54 is a diagram for explaining the fourth display example according to the fourth embodiment.

### DETAILED DESCRIPTION OF THE EMBODIMENTS

An projection display apparatus according to embodiments of the present invention will be described below with reference to the accompanying drawings. In the following drawings, identical or similar constituents are denoted by identical or similar reference numerals.

It should be noted that the drawings are schematic and ratios of dimensions and the like are different from actual ones. Therefore, specific dimensions and the like should be determined in consideration of the following description. Moreover, the drawings also include portions having different dimensional relationships and ratios from each other.

### Overview of First and Second Embodiments

The projection display apparatuses according to the first and second embodiments each include an image light generator configured to generate image light; and a mirror (aspheric mirror) configured to reflect the image light emitted from the image light generator to the projection plane side. Each projection display apparatus further includes a power supply unit (battery unit) configured to supply electric power to the image light generator, and the power supply unit is provided apart from the mirror as far as possible, specifically, is provided in the bottom portion of the projection display apparatus when the mirror is provided in the top portion thereof. Further, each projection display apparatus includes a cooling unit configured to cool the image light generator, and the cooling unit is also provided apart from the mirror as far as possible, specifically, is provided slightly above the power supply unit.

Furthermore, each of the projection display apparatuses according to the first and second embodiments includes a housing configured to house at least the image light generator; and a transmissive region (projection window) provided in the upper portion of the housing, and is configured to project image light through the transmissive region. The housing has a moving unit (sliding unit) whose dimension in at least one direction (Z-axis direction) is changeable, and when image light is not projected, the transmissive region is retracted into the inside of the housing by the moving unit, so that the transmissive region is moved to a hidden location.

Furthermore, each of the projection display apparatuses according to the first and second embodiments includes a detector (such as a tilt sensor) configured to detect a state of the projection display apparatus to a projection plane; and a controller configured to control the state of image light according to the detected state.

### First Embodiment

### Configuration of Projection Display Apparatus

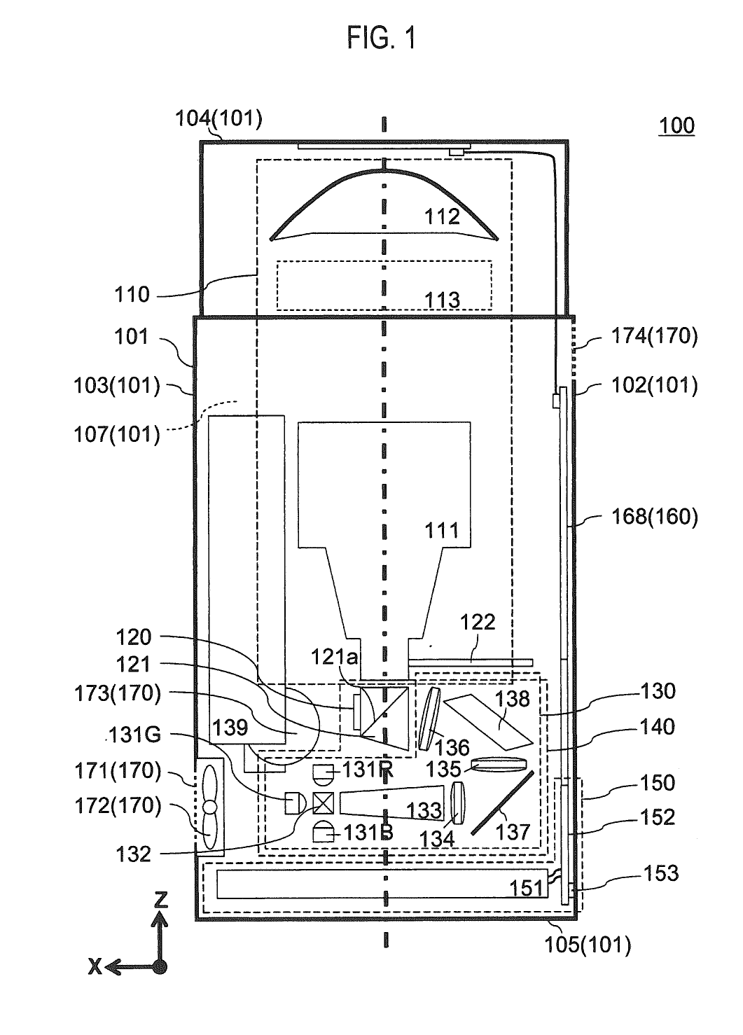

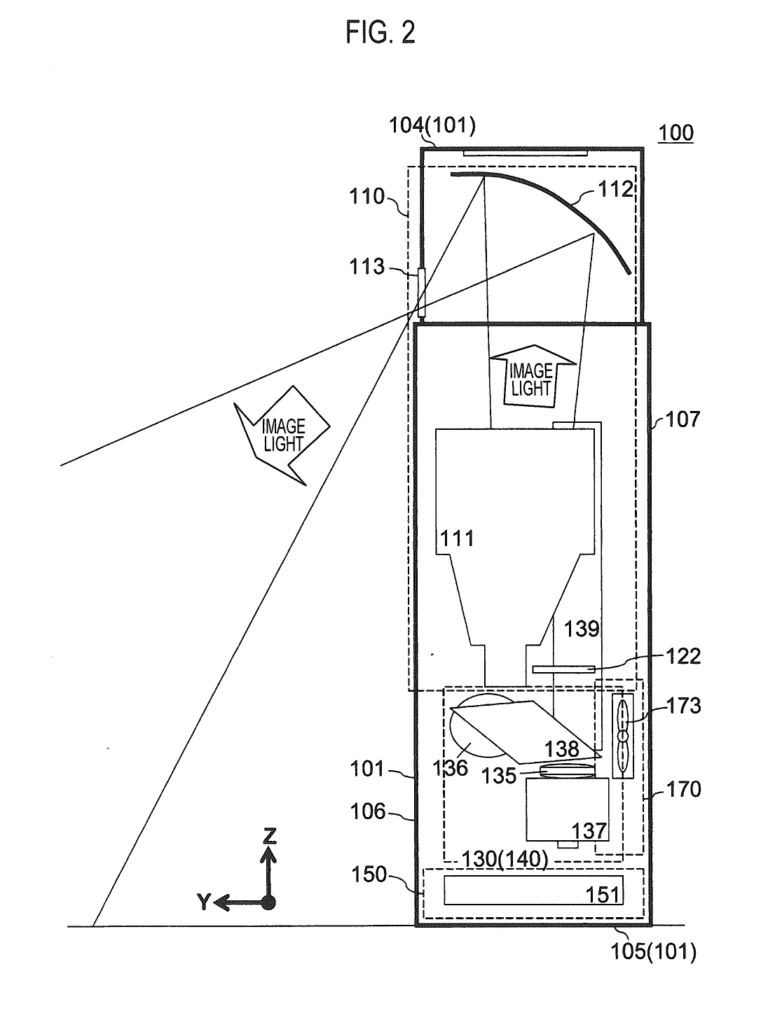

In the following, the configuration of a projection display apparatus according to the first embodiment is described with reference to the drawings. FIG. 1 is a front view and FIG. 2 is a side view, both showing the configuration of the projection display apparatus according to the first embodiment.

As shown in FIG. 1, the projection display apparatus 100 has a projecting unit 110 including a projection lens group 111 and an aspheric mirror 112; a DMD (Digital Micromirror Device) 120 as an imager; an illuminating unit 130 configured to emit light to the DMD 120; and a battery unit 150 configured to supply electric power to the DMD 120 and LEDs (Light Emitted Device) 131 or the like included in the illuminating unit 130.

In the present embodiment, the projection display apparatus 100 is one configured to be mounted in such a manner that the battery unit 150 is located in the lowest portion of the projection display apparatus 100. The surface (horizontal plane) on which the projection display apparatus 100 is mounted is defined as the XY plane, and the direction perpendicular (vertical direction) to the installation surface is defined as the Z-axis direction. The X-axis direction is defined as the direction corresponding to the width direction of a housing 101 in the projection display apparatus 100, and the Y-axis direction is defined as the direction corresponding to the depth direction in the housing 101.

In FIG. 1, the housing 101 has a one side surface 102 as the right side surface, other side surface 103 as the left side surface, a top surface 104 as the upper surface, and a bottom surface 105 as the lower surface. Also, the housing 101 has a front surface 106 as a surface on the side from which the image light is emitted in FIG. 2, and a rear surface 107 in the back of the front surface 106.

The projecting unit 110 has the projection lens group 111 including multiple lenses, the aspheric mirror 112 including an aspheric concave mirror, and a projection window 113 (see FIG. 2) through which image light is emitted. The projection lens group 111 emits image light modulated in the DMD 120 in the Z-axis direction. The aspheric mirror 112 is provided above the projection lens group 111, and reflects the image light from the projection lens group 111 below. Because the aspheric mirror 112 is a concave mirror, the image light collected by the aspheric mirror 112 is projected in an enlarged manner. The projection window 113 is provided in the vicinity of the position where the image light is focused. The image light forms an image between the projection lens group 111 and the aspheric mirror 112, and forms an image again on the installation surface (the XY plane in the figure) of the projection display apparatus 100.

The DMD 120 modulates blue, green, and red illumination light emitted in a time-division manner from the illuminating unit 130 according to an image input signal. The DMD 120 is provided integrally with a prism block 121 which leads the image light to the projection lens group 111. The prism block 121 has a surface 121a that transmits the illumination light from the illuminating unit 130, while totally reflecting the image light modulated in the DMD 120, and leads the reflected image light to the projection lens group 111. In the vicinity of the DMD 120, a DMD control circuit 122 configured to control the DMD 120 is disposed. The DMD control circuit 122 controls the DMD 120 according to an image input signal and an LED control signal.

The illuminating unit 130 has LEDs 131R, 131G, 131B which emit red, green, blue light; and multiple optical members which combine blue, red, and green light and emit the combined light to the DMD 120. In the present embodiment, a dichroic prism 132 is used as an optical member configured to combine red, green, and blue light. The light quantity distribution of the light combined by the dichroic prism 132 is made uniform by using a tapered rod 133. Lenses 134, 135, 36 in the back of the tapered rod 133 have a function of making the light emitted from the tapered rod 133 parallel as well as forming an image at the DMD 120. Mirrors 137 and 138 have a function of bending the optical path of the combine light according to available space.

A LED control circuit 139 configured to control the LEDs 131 is disposed in the vicinity of the LED 131. The LED control circuit 139 controls light emission quantity and light emission timing of the LEDs 131R, 131G, and 131B according to an image input signal. The LED control circuit 139 also sends an LED control signal related to the light emission quantity and the light emission timing to the DMD control circuit 122. The LED control circuit 139 is preferably disposed in the vicinity of the LEDs 131 in order to achieve short wiring. On the other hand, the LED control circuit 139 is also preferably disposed apart from the DMD control circuit 122 as far as possible in consideration of the influence of electromagnetic waves.

The DMD 120 and the illuminating unit 130 are collectively referred to as an image light generator 140.

The battery unit 150 has a battery 151 including nickel hydride secondary batteries, a battery control circuit 152 configured to control the charge and discharge of the battery 151, and a power source connector 153 connected to a commercial power source. The battery 151 has a shape such that the dimension in the X-axis or Y-axis direction is sufficiently larger (twice or more) than the dimension in the Z-axis direction. The battery control circuit 152 controls the electric power supplied from the commercial power source to the battery 151 via the power source connector 153, while controlling the electric power supplied from the battery 151 to the image light generator 140 (particularly, the LEDs 131 and the DMD 120). A lithium ion secondary battery or a capacitor may be used as a battery other than a nickel hydride secondary battery.

The controller 160, when roughly divided, includes the DMD control circuit 122, the LED control circuit 139, and a control circuit 168 configured to control the entire projection display apparatus 100. Specifically, the control circuit 168 is disposed in an area beside the one side surface 102 of the projecting unit 110 (particularly, the projection lens group 111), and the control circuit 168 sends a control signal to the DMD control circuit 122 and the LED control circuit 139 according to e.g., an image input signal. Although the details are described later, the image input signal is inputted from image connectors 161 and 162, a slot 163 for an SD card, a USB connector 164, and a LAN connector 165 that are connected to the control circuit 168. The control circuit 168 is also connected to a power switch 166 and manual operation buttons 167. The control circuit 168 controls the entire projection display apparatus 100 according to a user's instruction from the power switch 166 or the manual operation buttons 167.

A cooling unit 170 is disposed in an area beside the other side surface 103 of the projection lens group 111. Specifically, an axial flow fan 172 provided in the vicinity of an outlet port 171, a sirocco fan 173 to cool the LEDs 131, and a heat sink (not shown) to cool the DMD 120 are disposed. The air for cooling the projection display apparatus 100 is supplied from an inlet port 174 provided in the upper portion of the one side surface 102, and is circulated inside the projection display apparatus 100, then is exhausted from the outlet port 171 provided below the other side surface 103 after cooling the controller 160 and the image light generator 140.

The projection display apparatus 100 can be efficiently cooled by disposing the inlet port 174 and the outlet port 171 at a position diagonal to the housing 101. Because the inlet port 174 and the outlet port 171 are disposed at the one side surface 102 and the other side faces 103, respectively, the inlet and outlet ports are not blocked even when the rear surface 107 is the installation surface. The inlet port 174 is closed by the later-described sliding unit when the projection display apparatus 100 is not in use. By this configuration, entry of e.g., dust into the inside of the projection display apparatus 100 can be prevented while it is stored. It is preferable to provide a separate inlet port for the sirocco fan 173, other than the inlet port 174.

### (External Configuration of Projection Display Apparatus)

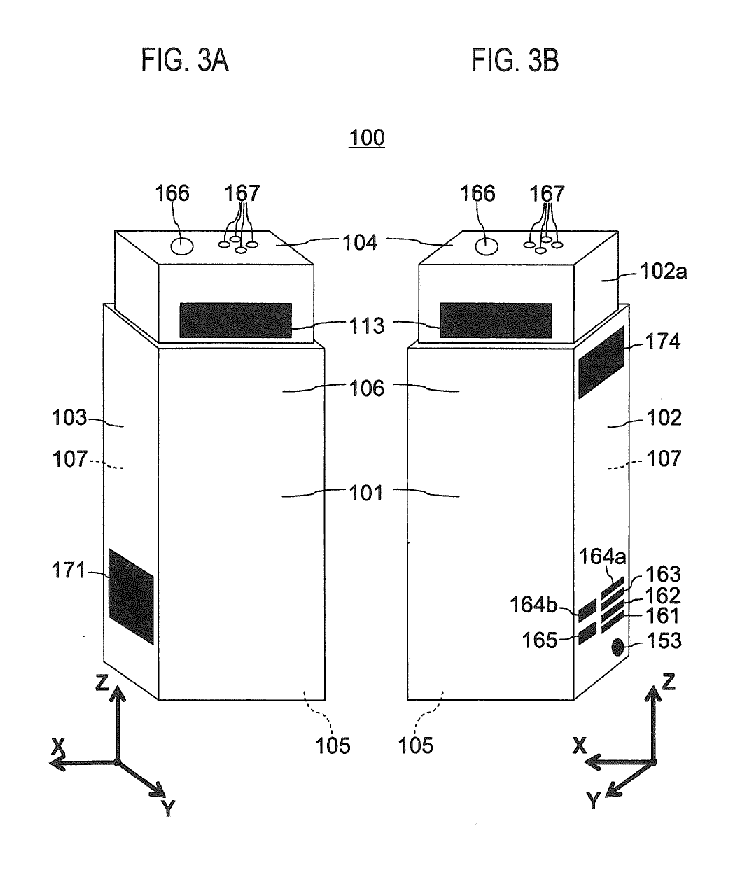

In the following, the external configuration of the projection display apparatus according to the first embodiment is described with reference to the drawings. FIGS. 3A and 3B are diagrams showing the external configuration of the projection display apparatus according to the first embodiment. FIG. 3A is a left perspective view; and FIG. 3B is a right perspective view.

The housing 101 is provided with the projection window 113, and has the front surface 106 on the side from which image light is emitted, and the rear surface 107 disposed in a position opposed to the front surface 106. Also, when the projection display apparatus 100 is installed in such a manner as to project image light onto a surface of a desk or a floor, the housing 101 has the top surface 104 as the upper surface, and the bottom surface 105 disposed in a position opposed to the top surface 104. In the projection display apparatus 100 having an approximately rectangular solid shape, out of the remaining two surfaces, the surface on which the above-mentioned power source connector 153 is disposed is the one side surface 102, and the surface arranged at a position opposed to the one side surface 102 is the other side surface 103.

On the one side surface 102, the image connectors 161, 162 connected to an image source such as a PC (Personal Computer), the slot 163 for SD card, USB connectors 164a, 164b, and the LAN connector 165 are provided in addition to the power connector 153. These connectors are preferably disposed in a portion close to the bottom surface 105, on the one side surface 102. The one side surface 102 has a superimposed unit 102a which is retracted by the later-described sliding unit when the projection display apparatus 100 is stored. The inlet port 174 on the one side surface 102 is preferably disposed in a position superimposed on a side surface 192 of the sliding unit 190 when the sliding unit 190 is retracted.

The outlet port 171 is provided on the other side surface 103. As described above, when the superimposed unit 102a is retracted, the inlet port 174 is located at a position superimposed on the one side surface 102, specifically, at a position on the one side surface 102, close to the top surface 104, thus the outlet port 171 is preferably provided at a portion on the other side surface 103, close to the bottom surface 105.

In consideration of operability, the power switch 166 and the manual operation buttons 167 are provided on the top surface 104. Because the bottom surface 105 and the rear surface 107 are installation surfaces, it is desirable not to provide an interface, inlet and outlet ports on these surfaces.

### (Configuration of Sliding Unit)

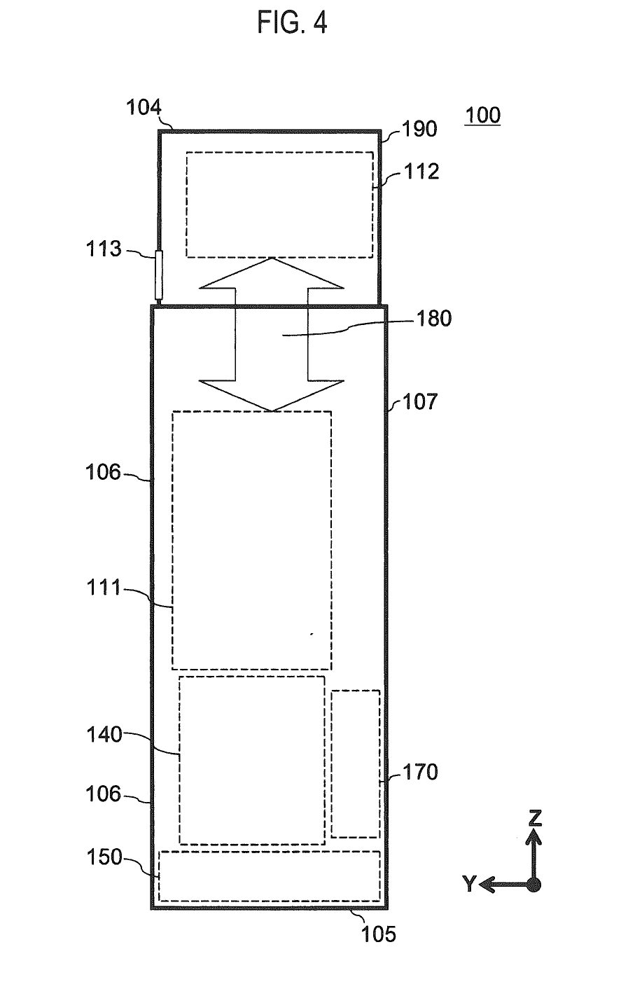

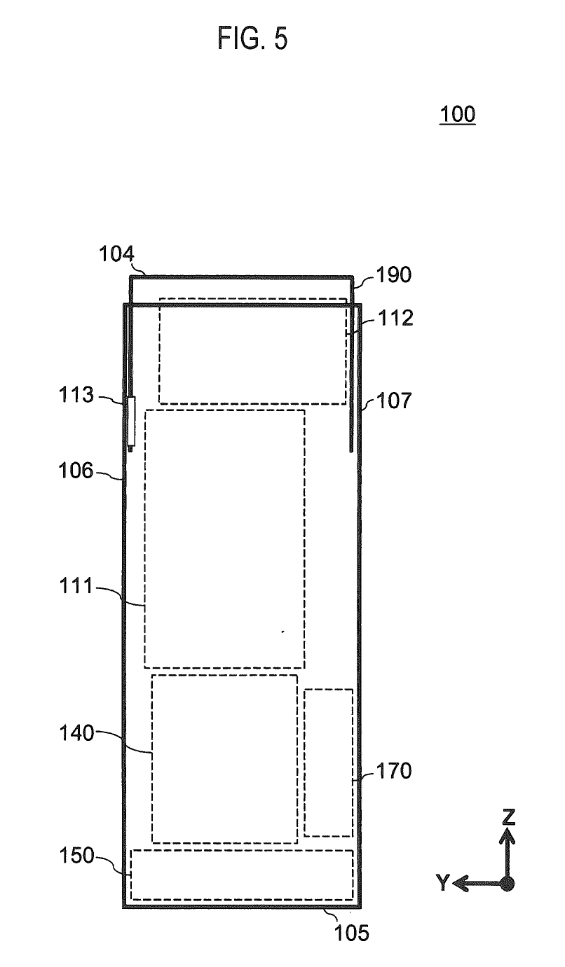

In the following, the configuration of the sliding unit of the projection display apparatus according to the first embodiment is described with reference to the drawings. FIG. 4 is a diagram showing the internal configuration of the projection display apparatus when image light is projected therefrom, and FIG. 5 is a diagram showing the internal configuration of the projection display apparatus when the sliding unit is retracted.

As shown in FIG. 4, the projection display apparatus 100, when projecting image light, needs to have a predetermined distance between the projection lens group 111 and the aspheric mirror 112. This distance (space 180) becomes dead space when no image light is projected. Thus, as shown in FIG. 5, when the sliding unit 190 is retracted, the sliding unit 190 including the aspheric mirror 112 and the projection window 113 is displaced in parallel in such a manner as to be retracted into the space 180.

Thereby, when the projection display apparatus 100 is not in use, the volume thereof can be made smaller. In addition, because the projection window 113 is moved to a position concealed behind the outer surface, and is superimposed on the front surface 106, further contamination of the projection window 113 can be avoided while it is stored. Because the inlet port 174 is superimposed on the one side surface 102 and is closed, entry of dust into the inside of the projection display apparatus 100 can be prevented.

### [Modification 1]

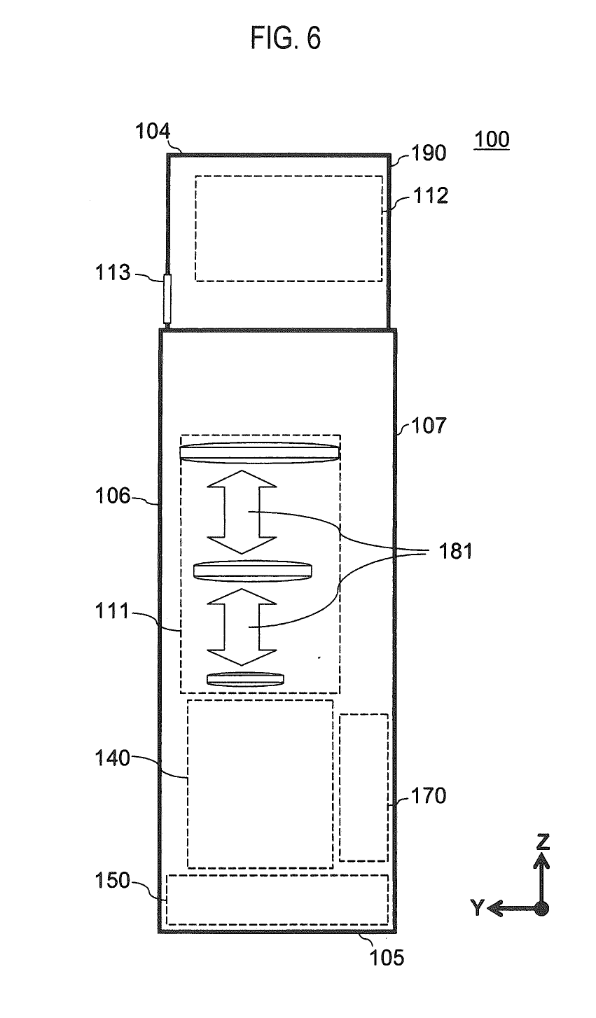

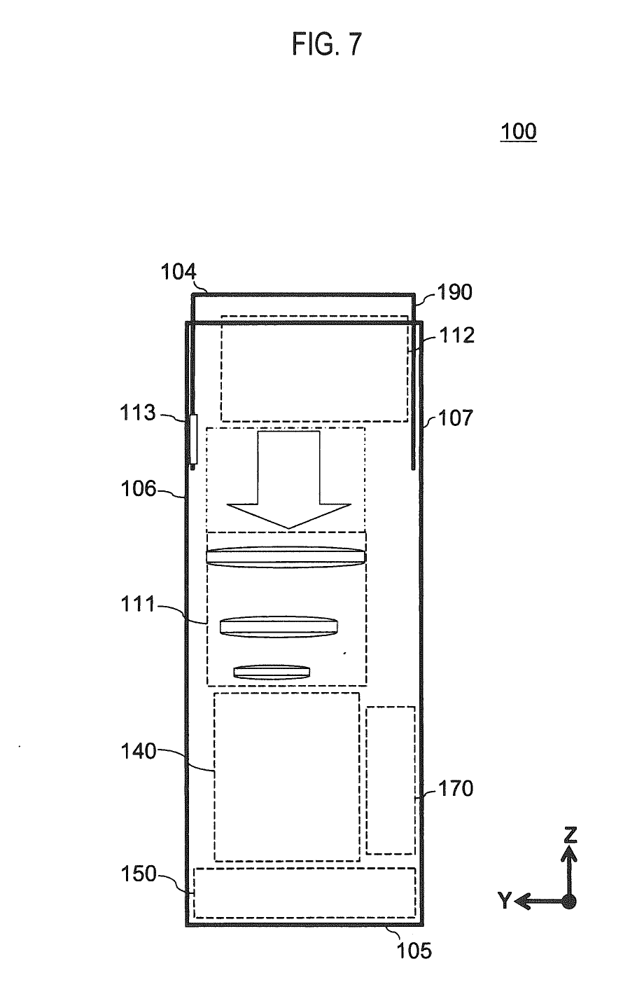

In the following, Modification 1 of the sliding unit according to the first embodiment is described with reference to the drawings. FIG. 6 is a diagram showing the internal configuration of the projection display apparatus when image light is projected therefrom, and FIG. 7 is a diagram showing the internal configuration of the projection display apparatus when the sliding unit is retracted.

As shown in FIG. 6, the projection display apparatus 100, when projecting image light, needs to have a predetermined distance between multiple lenses disposed in the projection lens group 111. This distance (space 181) becomes dead space when no image light is projected. Thus, as shown in FIG. 7, when the sliding unit 190 is retracted, the distances between the lenses of the projection lens group 111 are narrowed as much as possible along with the parallel movement of the sliding unit 190. By reducing the dimension in the Z-axis direction of the projection lens group 111, the sliding unit 190 including the aspheric mirror 112 and the projection window 113 is retracted into the space 181.

### [Modification 2]

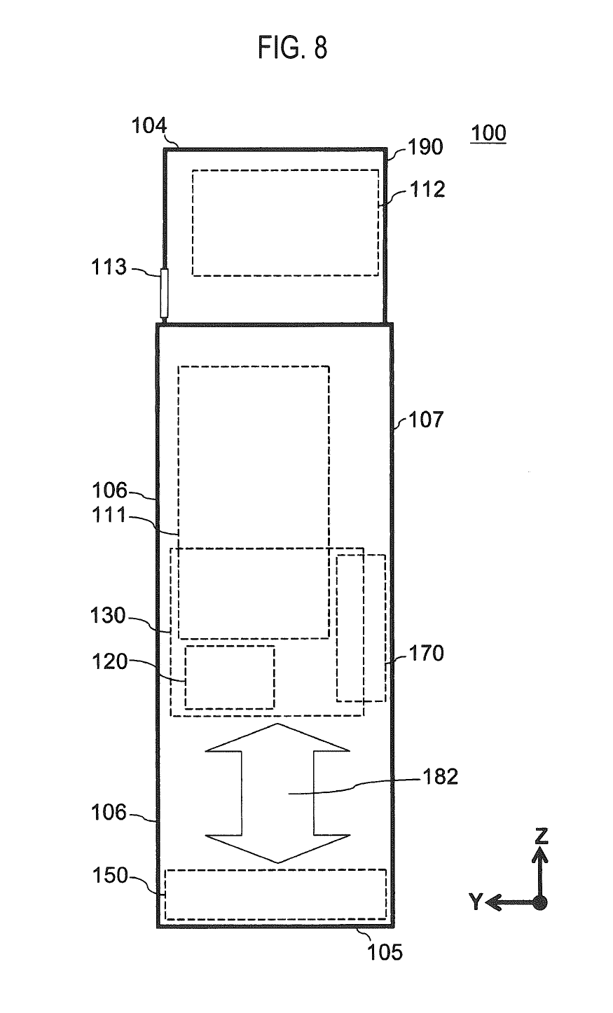

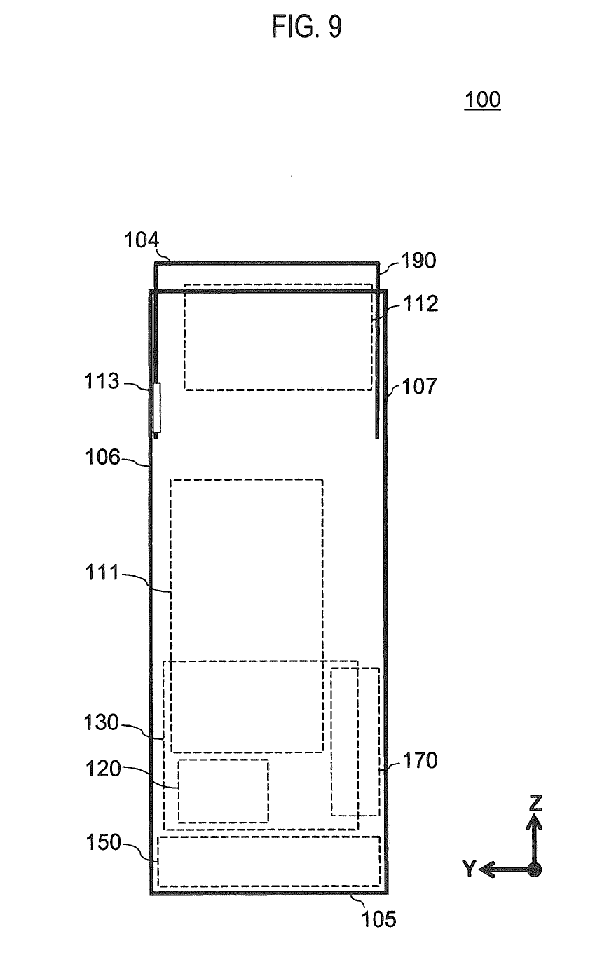

In the following, another modification of the sliding unit according to the first embodiment is described with reference to the drawings. FIG. 8 is a diagram showing the internal configuration of the projection display apparatus when image light is projected therefrom, and FIG. 9 is a diagram showing the internal configuration of the projection display apparatus when the sliding unit is retracted.

As shown in FIG. 8, in Modification 2, arrangement of the DMD 120 and the illuminating unit 130 is changed in such a manner that the illuminating unit 130 is disposed in an area beside the lens with a small diameter, of the projection lens groups 111. According to the positional change of the illuminating unit 130, the cooling unit 170 also needs to be moved to an area corresponding to the position of the DMD 120 and the illuminating unit 130.

In the projection display apparatus 100 according to Modification 2, when image light is projected, a space 182 is created between the DMD 120, the illuminating unit 130 (corresponding to the image light generator 140), and the battery unit 150. Thus, as shown in FIG. 9, when the sliding unit 190 is retracted, the projection lens group 111, the image light generator 140, and the cooling unit 170 are displaced in parallel in such a manner as to be retracted into the space 182 along with the sliding unit 190 including the aspheric mirror 112 and the projection window 113.

### [Modification 3]

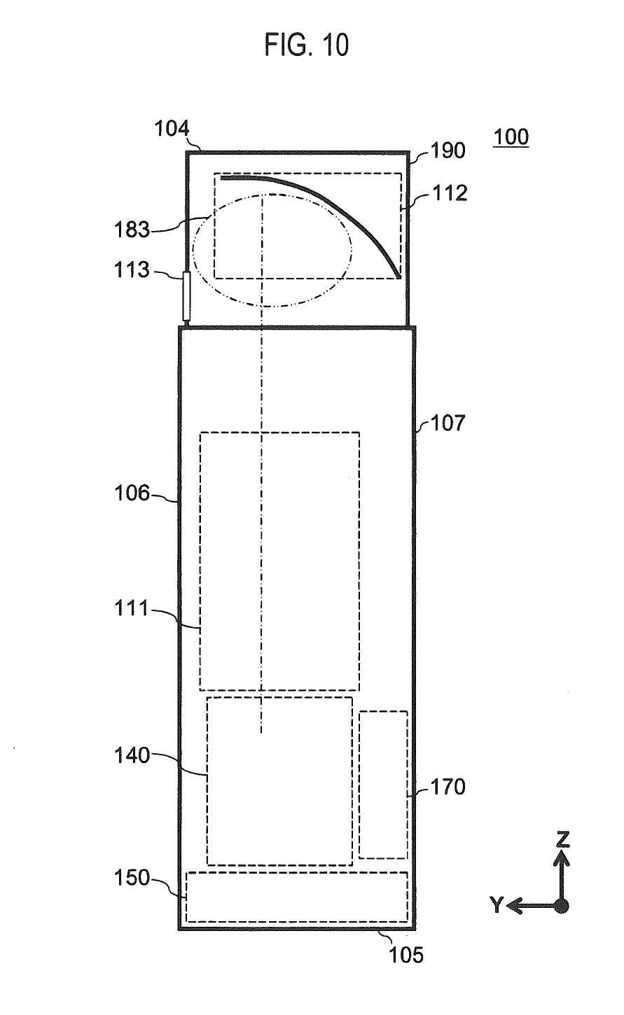

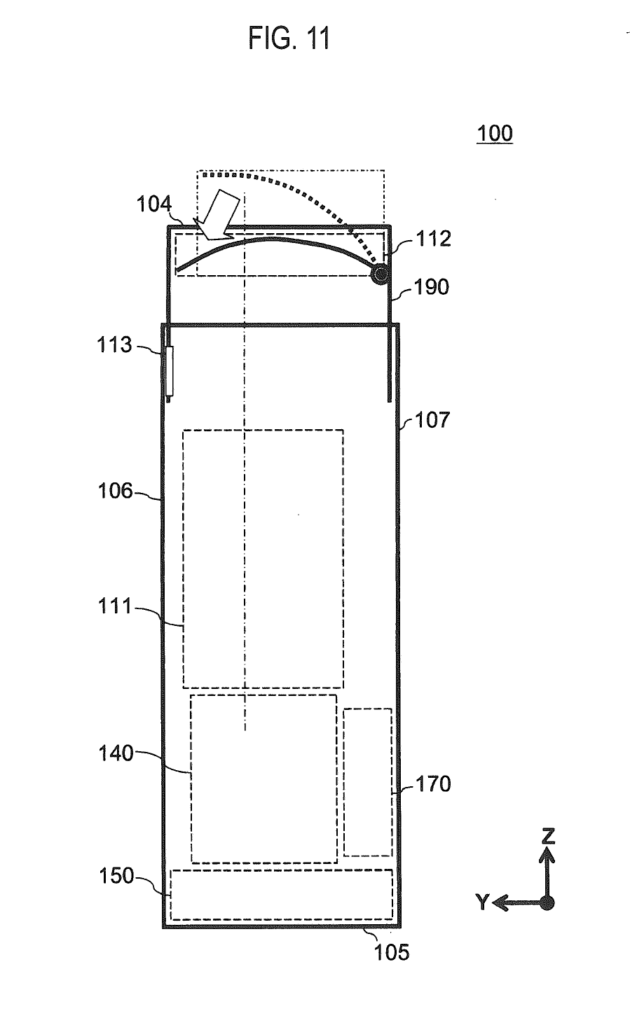

In the following, another modification of the sliding unit according to the first embodiment is described with reference to the drawings. FIG. 10 is a diagram showing the internal configuration of the projection display apparatus when image light is projected therefrom, and FIG. 11 is a diagram showing the internal configuration of the projection display apparatus when the sliding unit is retracted.

As shown in FIG. 10, the aspheric mirror 112, when projecting image light, is arranged on the rear surface 107 side in such a manner as to be inclined to the rear surface 107 with respect to the optical axis of the projection lens group 111. Thus, as shown in FIG. 11, when the sliding unit 190 is retracted, the aspheric mirror 112 is rotated around one end thereof as a central axis along with the parallel movement of the sliding unit 190. With the rotation of the aspheric mirror 112, the dimension in the Z-axis direction of the projection display apparatus 100 becomes smaller, and the sliding unit 190 including the projection window 113 is retracted into a space 183.

### [Other Modification]

In addition to the above-described examples, the cooling unit 170 may be disposed below the illuminating unit 130 (the image light generator 140) with a space provided between the cooling unit 170 and the illuminating unit 130. In this case, the sliding unit 190 including the projecting unit 110 and the image light generator 140 is retracted into the space.

The DMD 120 may be arranged perpendicular to the optical axis of the projection lens group 111 with a space provided between the projection lens group 111 and the DMD 120 without using the prism block 121. In this case, the projecting unit 110 is retracted into the space.

### (Operations and Effects)

According to the first embodiment, the projection display apparatus 100 includes the image light generator 140 configured to generate image light; and the aspheric mirror 112 configured to reflect the image light emitted from the image light generator to the projection plane side. The projection display apparatus 100 includes the battery unit 150 configured to supply electric power to the image light generator 140. The battery unit 150 is provided apart from the aspheric mirror 112 as far as possible, specifically, is provided in the bottom portion of the projection display apparatus 100, while the aspheric mirror 112 is provided in the top portion thereof. Accordingly, the aspheric mirror 112 and the battery unit 150 both relatively heavy are provided apart from each other, thus the weight balance of the entire apparatus can be maintained in a balanced state.

Also, in the first embodiment, the projection display apparatus 100 includes the image light generator 140 configured to generate image light, the housing 101 configured to house the image light generator 140, and the projection window 113 through which the image light is emitted from the image light generator 140 provided in the housing 101. The housing 101 has the sliding unit 190 whose dimension in the Z-axis direction is changeable. The projection window 113 is retracted into the inside of the housing 101 by the sliding unit 190 when no image light is projected. Accordingly, scratch or contamination of the projection window 113 can be avoided.

### Second Embodiment

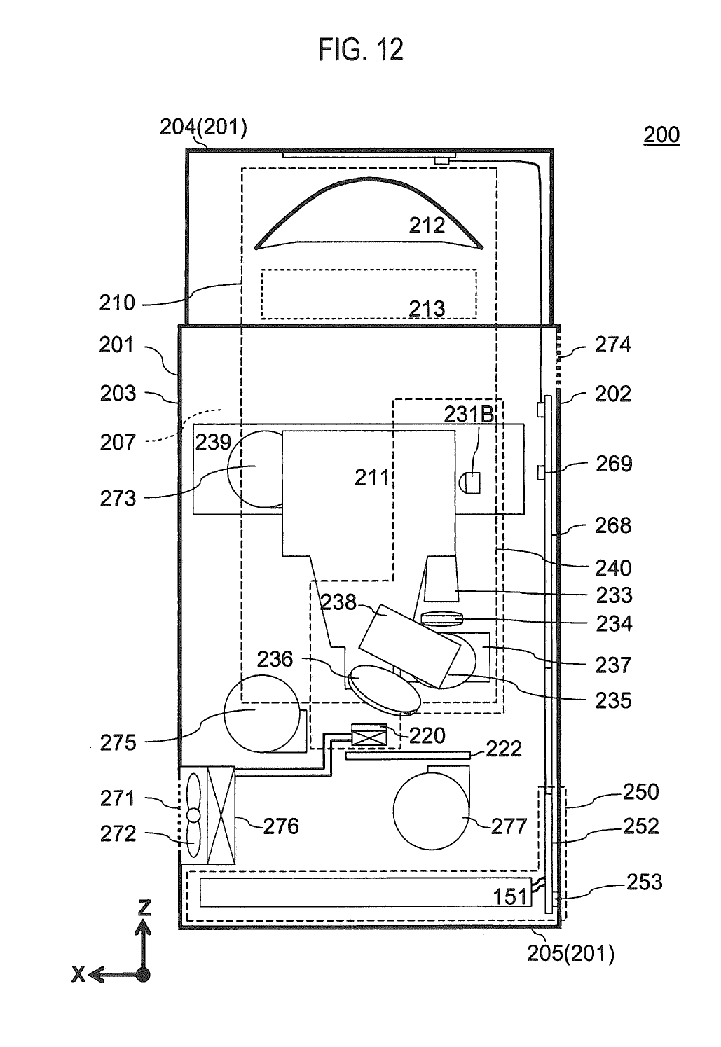

In the following, the configuration of a projection display apparatus according to a second embodiment is described with reference to the drawings. In the second embodiment, redundant description similar to the first embodiment is omitted. FIG. 12 is a front view showing the configuration of the projection display apparatus according to the second embodiment.

It should be noted that the configuration of an image light generator 240 and the arrangement of a cooling unit 270 of a projection display apparatus 200 greatly differ from those in the first embodiment as shown in FIG. 12. Also, in this embodiment, the state where a bottom surface 205 is defined as the installation surface (horizontal plane) and image light is projected onto a horizontal plane such as a floor or a surface of a desk is referred to as a floor surface projection mode, while the state where a rear surface 207 is defined as the installation surface (horizontal plane) and image light is projected onto a vertical plane such as a screen or a wall is referred to as a wall surface projection mode.

In this embodiment, LEDs 131R, 131G, 131B which emit red, green, blue light, a dichroic prism 232, a tapered rod 233 are disposed closer to the rear surface 207 than a projection lens group 211 is. In FIG. 12, these optical members are located behind the projection lens group 211. The light emitted from the tapered rod 233 is bent by lenses 234, 235, 236 and mirrors 237, 238 in such a manner as to fit the path of combine light into given space, and forms an image at DMD 220.

The DMD 220 is disposed in such a manner as to be perpendicular to the optical axis of the projection lens group 211. Thus, a prism block is not needed in the second embodiment. The combine light guided by the optical members of an illuminating unit 230 from a direction forming an acute angle with respect to the optical axis of the projection lens group 211 is emitted to the DMD 220. The DMD 220 reflects image light modulated from the combine light according to an image input to the projection lens group 211. A DMD control circuit 222 configured to control the DMD 220 is disposed in the vicinity of the DMD 220. In the second embodiment, the DMD control circuit 222 is disposed on the rear surface of the DMD 220.

In the second embodiment where an LED control circuit 239 configured to control the LEDs 231 is disposed in the vicinity of the LEDs 231, the LED control circuit 239 is disposed on the rear surface 207 side of the outer lens of the projection lens group 211. Thereby, the LED control circuit 239 is disposed in the vicinity of the LED 231, while being disposed apart from the DMD control circuit 222 as far as possible.

A control circuit 268 of a controller 260 has a tilt sensor 269. The tilt sensor 269 transmits information related to detected tilt to the control circuit 268. Using the received information, the control circuit 268 determines whether a user uses the projection display apparatus 200 in a floor surface projection mode with the bottom surface 205 being the installation surface, or in a wall surface mode with the rear surface 207 being the installation surface. The control circuit 268 sends a control signal to the DMD control circuit 222 according to the determined mode. Although the details are described later, the DMD control circuit 222 controls the size and the aspect ratio of the effective region of the DMD 220, and the vertical and horizontal directions of a projection image according to the control signal related to the projection mode.

A cooling unit 270 is disposed in an area beside other side surface 203 of the projection lens group 211. In the second embodiment, a sirocco fan 275 and a heat sink 276 to cool the DMD 220 are disposed in addition to a sirocco fan 273 to cool the LEDs 231.

### (Projection Mode Switch Function)

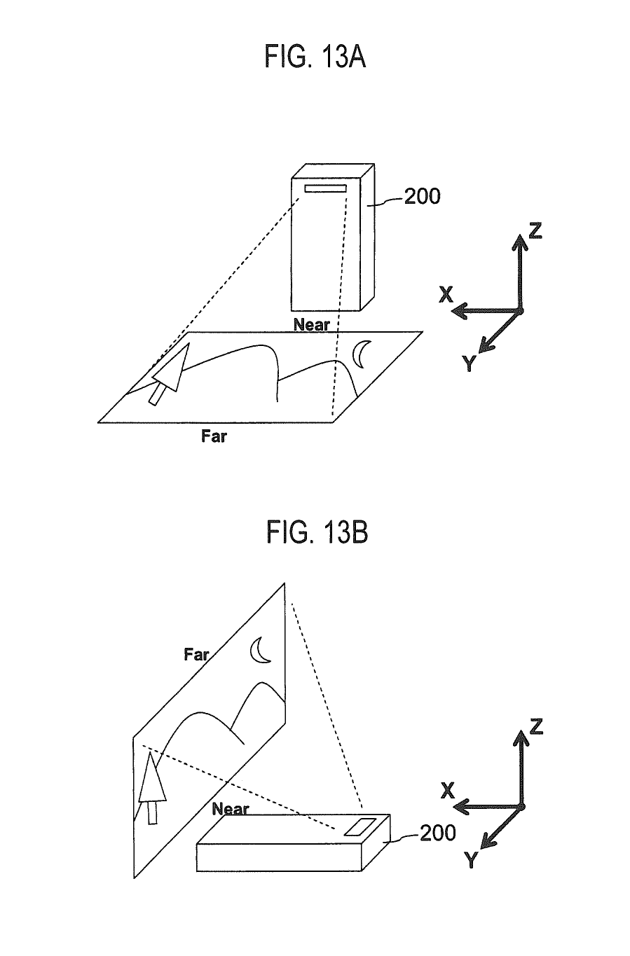

In the following, the projection mode switch function of the projection display apparatus according to the second embodiment is described with reference to the drawings. FIGS. 13A and 13B are diagrams showing the projection modes of the projection display apparatus according to the second embodiment. FIG. 13A shows the floor surface projection mode; and the FIG. 13B shows the wall surface projection mode.

The projection display apparatus 200, when projecting image light, determines the installation surface according to the information related to a tilt detected by the tilt sensor 269. When the installation surface is the bottom surface 205 as shown in FIG. 13A, the projection display apparatus 200 projects an image with Far side down (which is the side of the image, far away from the projection display apparatus 200) because, in many cases, a user (observer) observes the projection image from the Far side of the projection image. Particularly, when the tilt sensor 269 determines that the bottom surface 205 is the installation surface, the control circuit 268 sends a control signal to the DMD control circuit 222 so that the Far side is down.

On the other hand, when the installation surface is the rear surface 207 as shown in FIG. 13B, the projection display apparatus 200 projects an image with Near side down (the Near side is the side of the image, nearest to the projection display apparatus 200) because a user (observer) observes the projection image with the Near side down. Particularly, when the tilt sensor 269 determines that the rear surface 207 is the installation surface, the control circuit 268 sends a control signal to the DMD control circuit 222 so that the Near side is down.

Accordingly, an image is projected with an appropriate orientation by only placing the projection display apparatus 200, thus convenience of users is improved.

### [Modification 1]

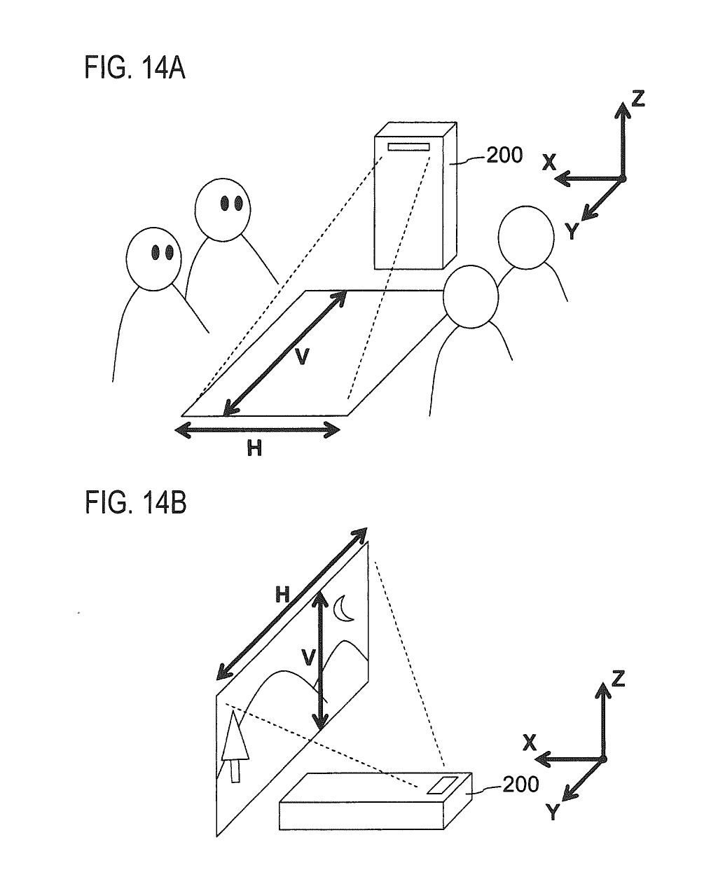

In the following, a modification of the projection mode switch function according to the second embodiment is described with reference to the drawings. FIGS. 14A and 14B are diagrams showing the projection modes of a projection display apparatus according to Modification 1. FIG. 14A shows the floor surface projection mode; and FIG. 14B shows the wall surface projection mode. Also, in Modification 1, the projection display apparatus 200, when projecting image light, determines the installation surface based on the information related to the tilt detected by the tilt sensor 269.

When the installation surface is the bottom surface 205 as shown in FIG. 14A, multiple users (observers) may observe a projection image along the opposed sides of the projection image, thus the projection display apparatus 200 projects an image in such a manner that the aspect ratio of the projection image indicates portrait orientation. Specifically, the control circuit 268 sends a control signal to the DMD control circuit 222 so that H:V equals 3:4.

On the other hand, when the installation surface is the rear surface 207 as shown in FIG. 14B, users (observers) observe a projection image from the front of the projection image, thus the projection display apparatus 200 projects an image in such a manner that the aspect ratio of the projection image indicates landscape orientation. Specifically, the control circuit 268 sends a control signal to the DMD control circuit 222 so that H:V equals 4:3.

### [Modification 2]

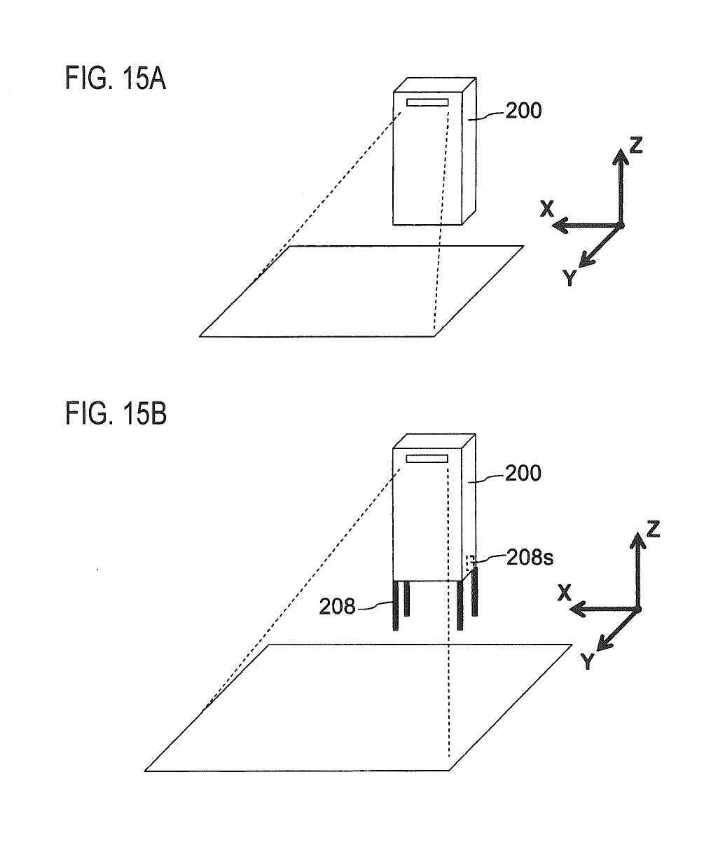

In the following, another modification of the projection mode switch function according to the second embodiment is described with reference to the drawings. FIGS. 15A and 15B are diagrams showing the projection modes of a projection display apparatus according to Modification 2. FIG. 15A shows normal floor surface projection mode (hereinafter referred to as a normal mode); and FIG. 15B shows the wall surface projection mode with a larger area of the projection image (hereinafter referred to as a magnification mode).

In Modification 2, the projection display apparatus 200 has legs 208 on the bottom surface 205, and a leg sensor 208s to detect the length of the legs 208. The projection display apparatus 200, when projecting image light, estimates the projection distance based on the information related to the length of the legs 208 detected by the leg sensor 208s. In the normal mode, for a region with the projection image area of S, suppose that E is the light quantity of the LEDs 231 required for them to project an image with the luminance of L.

When the legs 208 are extended from the bottom surface 205, and the distance (projection distance) between the projection window 203 and the installation surface is increased, the area S′ of the projection image in the magnification mode becomes larger than the area S in the normal mode (S′>S). If the light quantity of the LEDs 231 is E at this point, the luminance of the projection image in the magnification mode becomes lower than the luminance L in the normal mode.

Thus, when the current mode is estimated to be magnification mode based on the information from the leg sensor 208s, the control circuit 268 sends a control signal to the LED control circuit 239 so that the light quantity E′ of the LEDs 231 becomes greater than E. Accordingly, the luminance L in the normal mode becomes approximately equal to the luminance L′ in the magnification mode (L≈L′).

### [Modification 3]

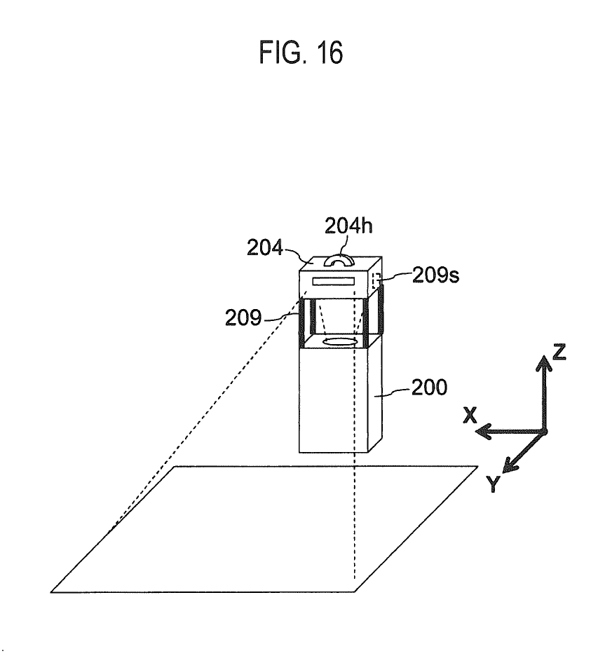

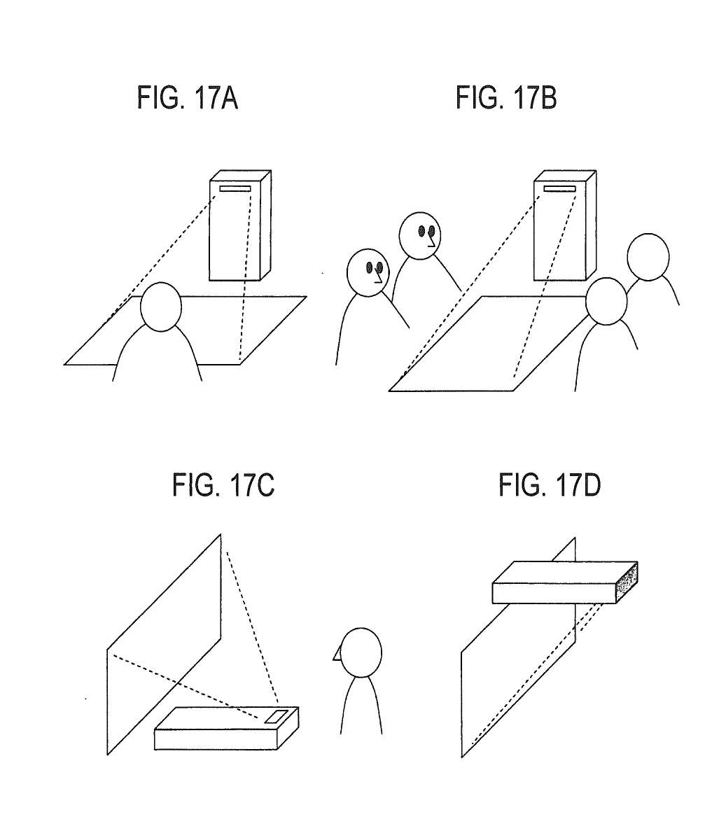

In the following, still another modification of the projection mode switch function according to the second embodiment is described with reference to the drawings. FIG. 16 is a diagram showing the floor surface projection mode of a projection display apparatus according to Modification 3. In Modification 3, only the difference between Modification 2 and Modification 3 is described.

In Modification 3, the projection display apparatus 200 has necks 209, and a neck sensor 209s to detect the length of the necks 209 in an upper portion. An aspheric mirror 212 is disposed above the necks 209, and the distance between the projection lens group 211 and the aspheric mirror 212 is adjusted by extending/contracting the necks 209. The projection display apparatus 200, when projecting image light, estimates the projection distance, and the distance between the projection lens group 211 and the aspheric mirror 212 based on the information related to the length of the necks 209 detected by the neck sensor 209s.

On the top surface 204, a handle 204h used for pulling the necks 209 is provided. A button (not shown) may be further provided to the handle 204h so that the necks 209 can be extended when the button is pressed. Because the necks 209 cannot be extended when the button is not pressed, the handle 204h is useful even when the projection display apparatus 200 is carried.

### [Other Modification]

In addition to the above-described examples, the projection display apparatus 200 may include an illuminance sensor. By the illuminance sensor, it is made possible to estimate the illuminance of the environment in which the projection display apparatus 200 is used. By controlling the light quantity E of the light source (the LEDs 231) according to the environment and the area S of the projection image, lower power consumption drive of the projection display apparatus 200 can be achieved, while images gentle to users' eyes can be provided.

Also, a combination of the above-described examples may be made. For example, when a projection image in landscape orientation is switched to another projection image in portrait orientation, the area S of the projection image is preferably increased by adjusting the legs 208. When an image in portrait orientation is projected, effective display region for the DMD 220 is modified by signal processing in the DMD control circuit 222. Thereby, the effective display region for the DMD 220 is reduced and the area S of the projection image is reduced. Now, increasing the projection distance by extending the legs 208 allows the area S to be maintained.

### (Operations and Effects)

According to the second embodiment, the projection display apparatus 200 includes the image light generator 240 configured to generate image light; and the aspheric mirror 212 configured to reflect the image light emitted from the image light generator 240 to the projection plane side. The projection display apparatus 200 includes the battery unit 250 configured to supply electric power to the image light generator 240. The battery unit 250 is provided at a position apart from the aspheric mirror 212 as far as possible.

Also, the projection display apparatus 200 further includes the cooling unit 270, some components of the cooling unit 270, specifically the axial flow fan 272, the sirocco fan 275, the heat sink 276, and the sirocco fan 277 are also preferably provided at a position near the bottom surface 205 and apart from the aspheric mirror 212 as far as possible. Accordingly, in addition to the aspheric mirror 212 and the battery unit 250, relatively heavy cooling unit 270 is provided at a position apart from the aspheric mirror 212, thus the weight balance of the entire apparatus can be maintained in a balanced state. Because the battery unit 250 and the cooling unit 270 are disposed closely in a position near the bottom surface, the projection display apparatus can be stably installed even when the bottom surface has a small area.

Also, in the second embodiment, the projection display apparatus 200 includes the tilt sensor 269 configured to detect a state of the projection display apparatus with respect to the projection plane, the leg sensor 208s, the neck sensor 209s, and controller 260 configured to control the state of image light according to detected state. Accordingly, the projection display apparatus 200 determines its state, specifically the installation surface and the projection distance, and projects image light in the most appropriate environment (such as orientation, brightness) for users to observe the image light, thus convenience of users is improved.

### Other Embodiments

Although the present invention has been described in conjunction with the above embodiments, it should be understood that the invention is not limited by the description and the drawings which form a part of this disclosure. From the disclosure, various alternative embodiments, application examples, application techniques will become apparent to those skilled in the art.

Although the housing has been described as an approximately rectangular parallelepiped shape having 6 surfaces, the shape of the housing is not limited to the rectangular parallelepiped, and may be a shape with more focus on design. Also, the vertices and edges of the rectangular parallelepiped may be rounded, and projections or depressions may be formed in the center portion or the vicinity of the centroid. The projections or depressions in the center portion or the vicinity of the centroid allow a user to carry the projection display apparatus conveniently.

Although the invention has been described using an LED as a light source, the light source is not limited to LED, and a laser light source as a fixed light source, a high pressure mercury lamp or a xenon lamp as a lamp light source may also be used. Although the invention has been described using the DMD as an imager, transmissive, semi-transmissive, or reflective liquid crystal panel may also be used.

Although the invention has been described using the configuration in which a nickel hydride battery is fixed as a battery unit to the bottom surface of the projection display apparatus, the nickel hydride battery may be connected to a battery controller via a connector in such a manner that the nickel hydride battery can be replaced with another battery. Also, the battery controller may control power supply in such a manner that electric power can be directly supplied from a commercial power source to each unit via a power connector. Accordingly, even when the remaining amount of a battery is reduced, images can be displayed for a longer period by replacing the battery with another one or supplying electric power from a commercial power source.

Activation of the projection display apparatus has been described by using a configuration in which a power switch is pressed, however, the sliding unit may serve as a power switch. That is to say, the configuration can be made such that the projection display apparatus is activated by pulling the sliding unit to make image light ready to be emitted from the projection window, and is stopped by retracting the sliding unit into the inside of the housing.

The aspect ratio of the projection image has been described using the ratio 4:3 (=H:V) as a standard, however, the aspect ratio may be 16:9 (=H:V).

Although the invention has been described using the configuration in which manual operation buttons and a switch are arranged on the top surface or the side surface of the housing, however, operation may be performed using a remote control. In this case, a light receiving unit configured to receive a signal from the remote control is preferably disposed on the upper portion of the front or side surface (the aspheric mirror side). By disposing the light receiving unit on a portion which is upside of the projection display apparatus when the projection display apparatus is in use, the signal is prevented from being blocked.

### Overview of Third Embodiment

A third embodiment of a projection display apparatus includes an imager configured to modulate light emitted from a light source; and a projection optics configured to project light emitted from the imager onto a projection plane. The projection display apparatus includes; a storage unit configured to store information which associates a specific region provided on the projection plane with processing detail to be performed by the projection display apparatus, a detection unit configured to detect an object blocking light in the specific region; and an instruction unit configured to instruct an execution of the processing detail associated with the specific region when an object blocking light is detected for a predetermined time period or longer in the specific region.

In the third embodiment, when an object blocking light is detected for a predetermined time period or longer in a specific region, an instruction unit instructs the execution of the processing detail associated with the specific region. Thus, a user's instruction (interactive operation) can be easily implemented without needing an image capturing device having a high image capture resolution.

### Third Embodiment

### Schematic Configuration of Projection Display Apparatus

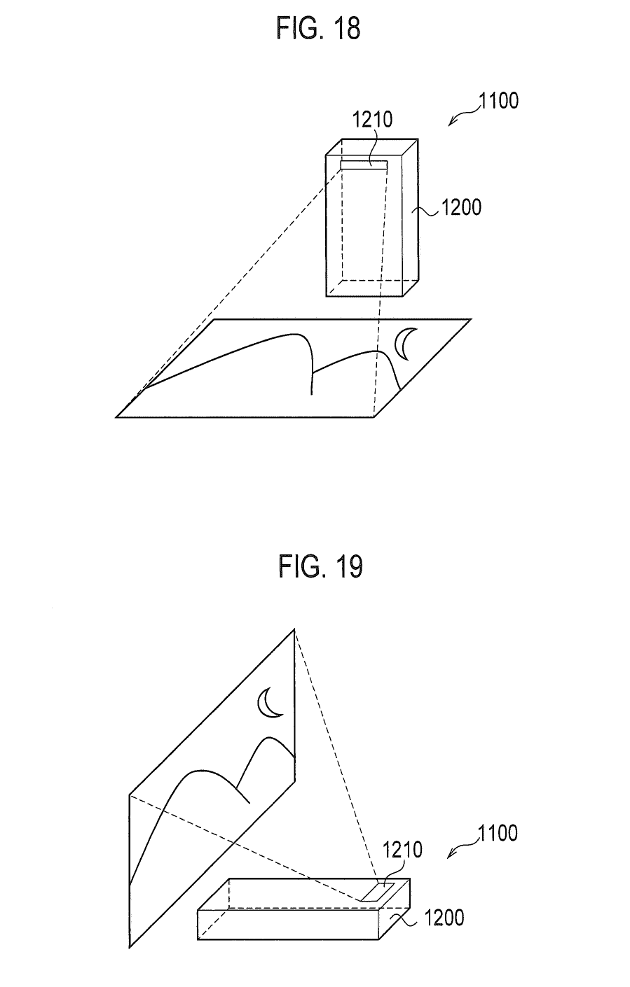

In the following, the schematic configuration of the projection display apparatus according to the third embodiment is described with reference to the drawings. FIG. 18 is a diagram showing a projection display apparatus 1100 (floor surface projection) according to the third embodiment. FIG. 19 is a diagram showing the projection display apparatus 1100 (wall surface projection) according to the third embodiment.

As shown in FIGS. 18 and 19, the projection display apparatus 1100 has a housing 1200 and projects an image onto a projection plane (not shown). The housing 1200 is provided with a transmissive region 1210 through which the light emitted from a later-described projection optics 1110 transmits.

The projection plane may be provided on a floor as shown in FIG. 18, or may be provided on a wall surface as shown in FIG. 19. That is to say, the projection display apparatus 1100 may be arranged in such a manner as to project image light onto a floor surface, or a wall surface.

Note that the size of each image displayed by the projection display apparatus 1100 is, for example, about 20 inches. Also, it should be noted that the distance between the projection display apparatus 1100 and the projection plane is substantially short.

### (Optical Configuration of Projection Display Apparatus)

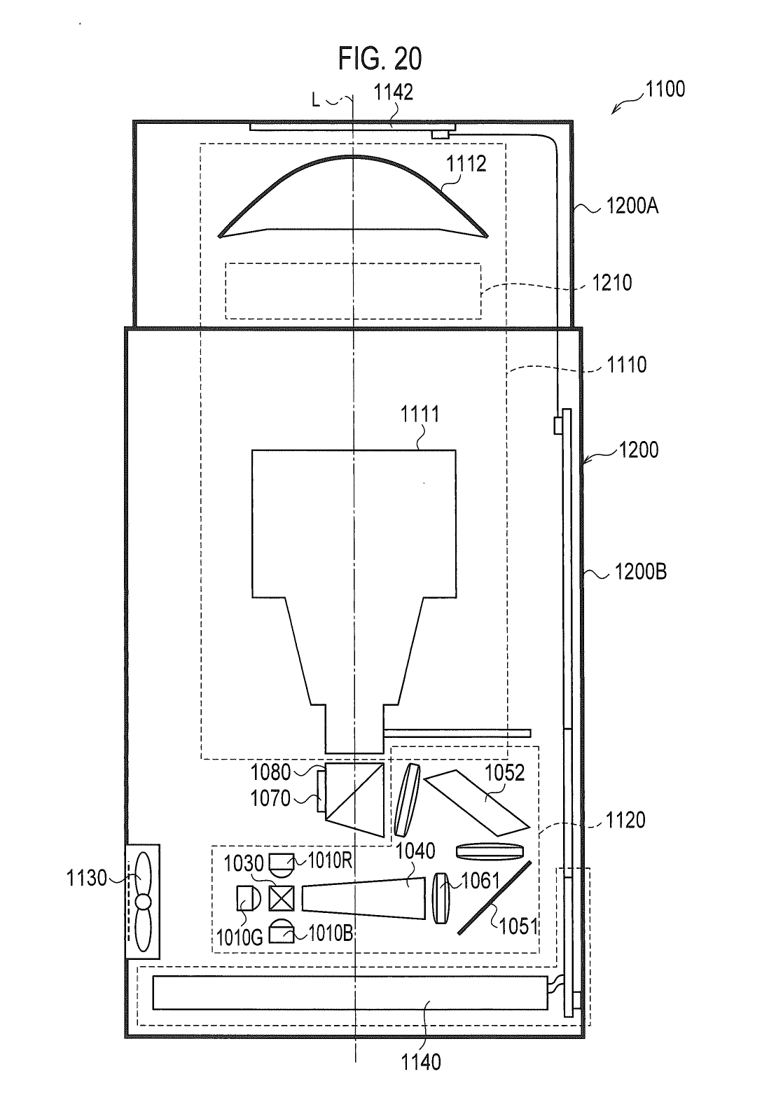

In the following, the optical configuration of the projection display apparatus according to the third embodiment is described with reference to the drawings. FIG. 20 is a diagram mainly showing the optical configuration of the projection display apparatus 1100 according to the third embodiment.

As shown in FIG. 20, the projection display apparatus 1100 has a projection optics 1110, an illumination optical system 1120, a cooling fan 1130, and a drive device 1140. The projection display apparatus 1100 also has a DMD 1070 and a reflection prism 1080.

Also, the housing 1200 includes a first housing 1200A and a second housing 1200B. The above-mentioned transmissive region 1210 is provided in the first housing 1200A. A part or all of the first housing 1200A is configured to be able to be housed in the second housing 1200B as described later.

The projection optics 1110 projects the color component light (image light) emitted from the DMD 1070 onto the projection plane. Specifically, the projection optics 1110 has a projection lens group 1111 and a reflection mirror 1112.

The projection lens group 1111 emits the color component light (image light) emitted from the DMD 1070 to the reflection mirror 1112. The projection lens group 1111 includes a lens in an approximately circular shape centered on the optical axis L of the projection optics 1110, and a lens in the shape defined by a part of an approximately circular shape centered on the optical axis L of the projection optics 1110 (for example, a lower half semicircular shape).

It should be noted that the diameter of a lens included in the projection lens group 1111 is greater as the lens is closer to the reflection mirror 1112.

The reflection mirror 1112 reflects the color component light (image light) emitted from the projection lens group 1111. The reflection mirror 1112, after collecting image light, diverges it. For example, the reflection mirror 1112 is an aspheric mirror which has a concave surface toward the projection lens group 1111. The reflection mirror 1112 has a shape defined by a part of an approximately circular shape centered on the optical axis L of the projection optics 1110 (for example, a lower half semicircular shape).

The image light collected by the reflection mirror 1112 transmits the transmissive region 1210 provided in the housing 1200. The transmissive region 1210 provided in housing 1200 is preferably provided in the vicinity of the location where image light is collected by the reflection mirror 1112.

The illumination optical system 1120 has a light source 1010, a dichroic prism 1030, a rod integrator 1040, a mirror 1051, a mirror 1052, a lens 1061, a lens 1062, and a lens 1063.

The light source 1010 is configured to individually emit color component light of each of multiple colors. Also, the light source 1010 may be provided nearby with a heat sink which radiates heat generated by the light source 1010. The light source 1010 includes, for example, a light source 1010R, a light source 1010G, and a light source 1010B.

The light source 1010R is a light source which emits red component light R, and is, for example, a red LED (Light Emitting Diode), or a red LD (Laser Diode). The light source 1010R may also be provided nearby with a heat sink composed of a member having high heat dissipation such as metal.

The light source 1010G is a light source which emits green component light G, and is, for example, a green LED, or a green LD. The light source 1010G may also be provided nearby with a heat sink composed of a member having high heat dissipation such as metal.

The light source 1010B is a light source which emits blue component light B, and is, for example, a blue LED, or a blue LD. The light source 1010B may also be provided nearby with a heat sink composed of a member having high heat dissipation such as metal.

The dichroic prism 1030 combines the red component light R emitted from the light source 1010R, the green component light G emitted from the light source 1010G, and the blue component light B emitted from the light source 1010B.

The rod integrator 1040 has a light incidence surface, a light emitting surface, and a light reflective lateral surface provided across from the circumference of the light incidence surface to the circumference of the light emitting surface. The rod integrator 1040 equalizes the color component light emitted from the dichroic prism 1030. Particularly, the rod integrator 1040 equalizes the color component light by reflecting it on the light reflective lateral surface. The rod integrator 1040 may be a solid rod composed of glass, or a hollow rod whose inner surface is formed of mirror surfaces.

For example, in the third embodiment, the rod integrator 1040 has a tapered shape with a greater cross-section along and perpendicular to the traveling direction of the light emitted from the light source 1010. However, the embodiment is not limited to this case. The rod integrator 1040 may have a reverse-tapered shape with a smaller cross-section along and perpendicular to the traveling direction of the light emitted from the light source 1010.

The mirror 1051 and mirror 1052 are reflection mirrors for bending an optical path in order to guide the light emitted from the rod integrator 1040 to the DMD 1070.

The lens 1061, lens 1062, and lens 1063 are relay lenses which form an image of the color component light emitted from the light source 1010 nearly on the DMD 1070, while suppressing the divergence of the color component light.

The cooling fan 1130 communicates with the outside of the housing 1200 and is configured to release the heat in the housing 1200. Alternatively, the cooling fan 1130 is configured to send the air outside of the housing 1200 into it. For example, the cooling fan 1130 is provided in the vicinity of the light source 1010, and is configured to cool the light source 1010.

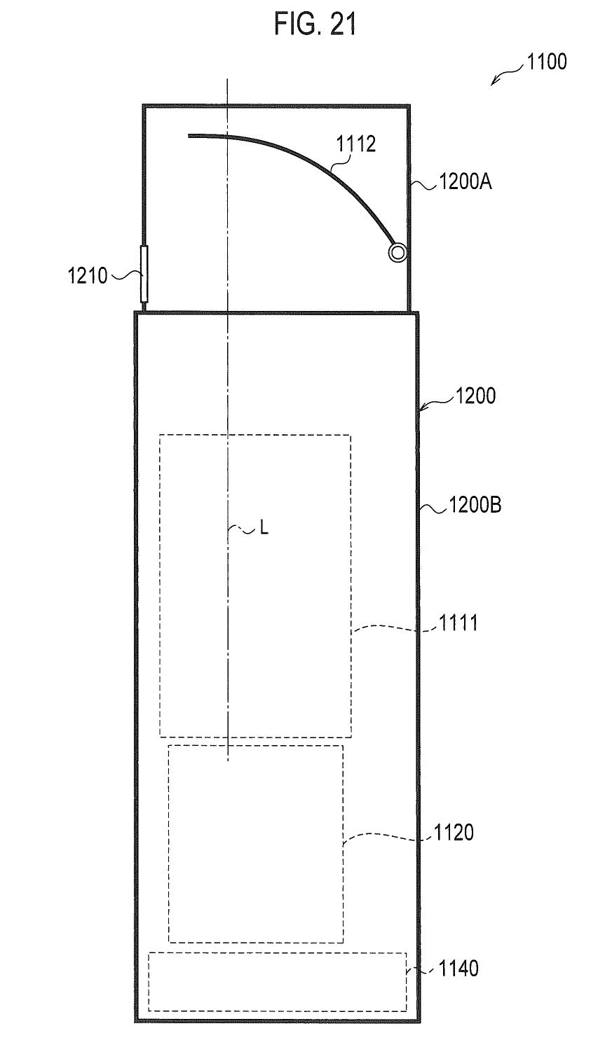

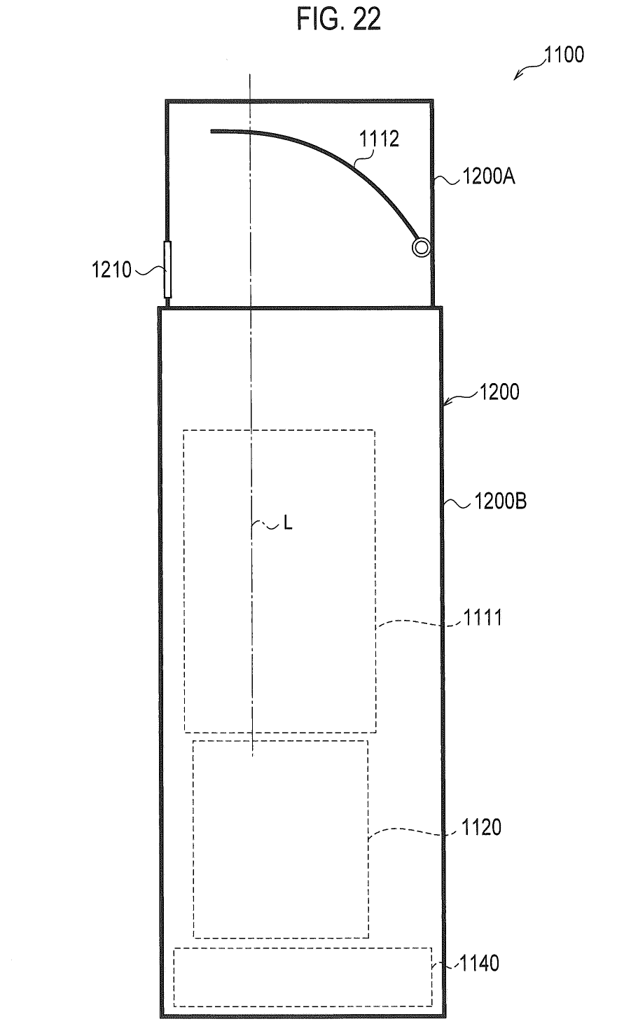

The drive device 1140 slides the first housing 1200A into the second housing 1200B along the inner wall thereof. Specifically, the drive device 1140 drives a sliding mechanism 1141 and a rotating mechanism 1142. As shown in FIGS. 21 and 22, the sliding mechanism 1141 slides the first housing 1200A into the second housing 1200B along the inner wall thereof. The rotating mechanism 1142 rotates the reflection mirror 1112 about the rotation axis P in conjunction with sliding of the first housing 1200A.

The DMD 1070 is formed of multiple micro mirrors, which are movable. Each micro mirror basically corresponds to 1 pixel. The DMD 1070 enables or disables the reflection of the color component light by changing the angle of each micro mirror so that the color component light is guided to the projection optics 1110 as effective light.

The reflection prism 1080 transmits the light emitted from the illumination optical system 1120 to the DMD 1070. On the other hand, the reflection prism 1080 reflects the light emitted from the DMD 1070 to the projection optics 1110.

### (Configuration of Control Unit)

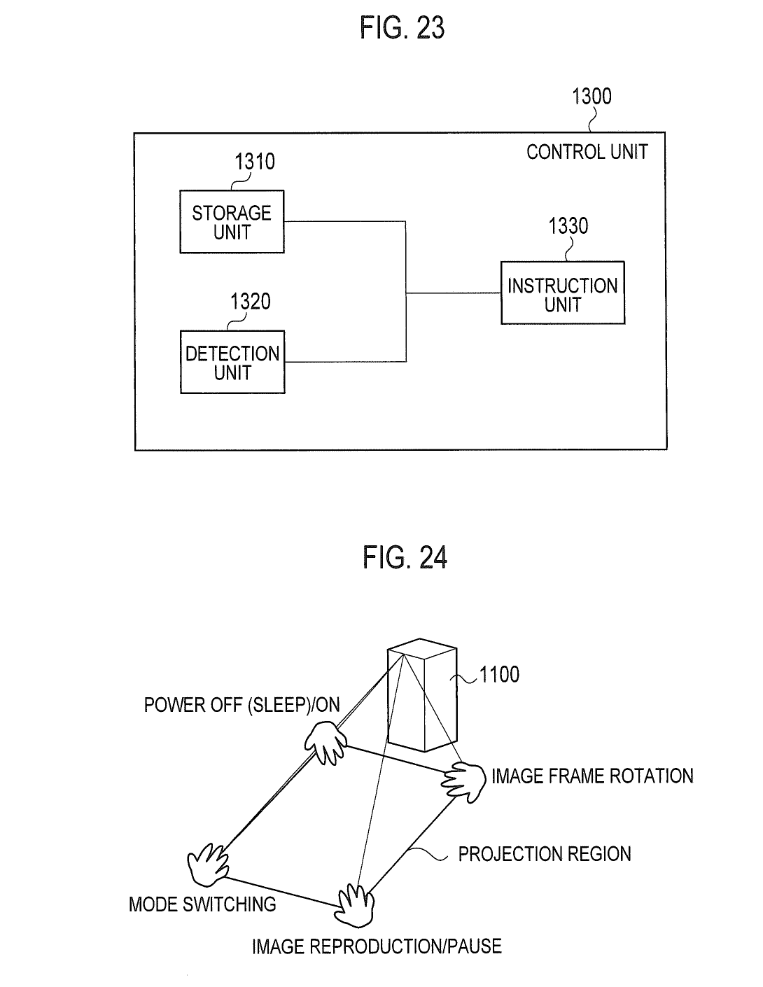

In the following, the control unit according to the third embodiment is described with reference to the drawings. FIG. 23 is a block diagram showing a control unit 1300 according to the third embodiment. The control unit 1300 is provided in the projection display apparatus 1100, and controls the projection display apparatus 1100.

As shown in FIG. 23, the control unit 1300 has a storage unit 1310, a detection unit 1320, and an instruction unit 1330.

The storage unit 1310 stores information which associates a specific region provided on the projection plane with processing detail to be performed by the projection display apparatus 1100.

The specific region may be provided inside or outside of the projection region where the light emitted from the projection display apparatus 1100 (the projection optics 1110) is projected. For example, the specific region is 4 sides of the projection region. Or the specific region is 4 corners of the projection region.

The specific region is preferably the boundary region between the inside and the outside of the projection region (for example, 4 sides of the projection region, 4 corners of the projection region). It should be noted that an object blocking light can be easily detected in the specific region because luminance is greatly varied in such boundary region.

Also, the processing detail is the processing to be performed by the projection display apparatus 1100. For example, the processing detail include switching ON/OFF of the power supply of the projection display apparatus 1100, rotation of an image projected on the projection region, switching between reproduction/pause of an image projected on the projection region, and switching between modes provided in the projection display apparatus 1100. The processing detail also includes, for example, Page Forward of an image projected on the projection region, Page Backward of an image projected on the projection region, Menu Call to change the configuration (brightness adjustment, contrast adjustment) of the projection display apparatus 1100.

The detection unit 1320 detects an object blocking light (for example, a user's hand) in the specific region. Specifically, in the third embodiment, the detection unit 1320 preferably detects an object in the specific region, which blocks the light emitted from the projection display apparatus 1100 (the projection optics 1110). That is to say, the specific region is preferably provided in the projection region.

The detection unit 1320 is, for example, an image capturing device configured to be able to detect a change in brightness in the specific region. Or the detection unit 1320 may be, for example, an illuminance sensor configured to be able to detect brightness conversion in the specific region. The illuminance sensor preferably has directivity for covering only the specific region.

When an object blocking light is detected for a predetermined time period or longer in the specific region, the instruction unit 1330 instructs the execution of the processing detail associated with the specific region. Specifically, for the processing detail that is completed within the projection display apparatus 1100, the instruction unit 1330 instructs a functional block (for example, power source block) provided in the projection display apparatus 1100 to execute the processing detail associated with the specific region. Otherwise, for the processing detail that is not completed within the projection display apparatus 1100, the instruction unit 1330 instructs other device (for example, a personal computer connected to the projection display apparatus 1100) to execute the processing detail associated with the specific region.

### (Execution Example of Processing Detail)

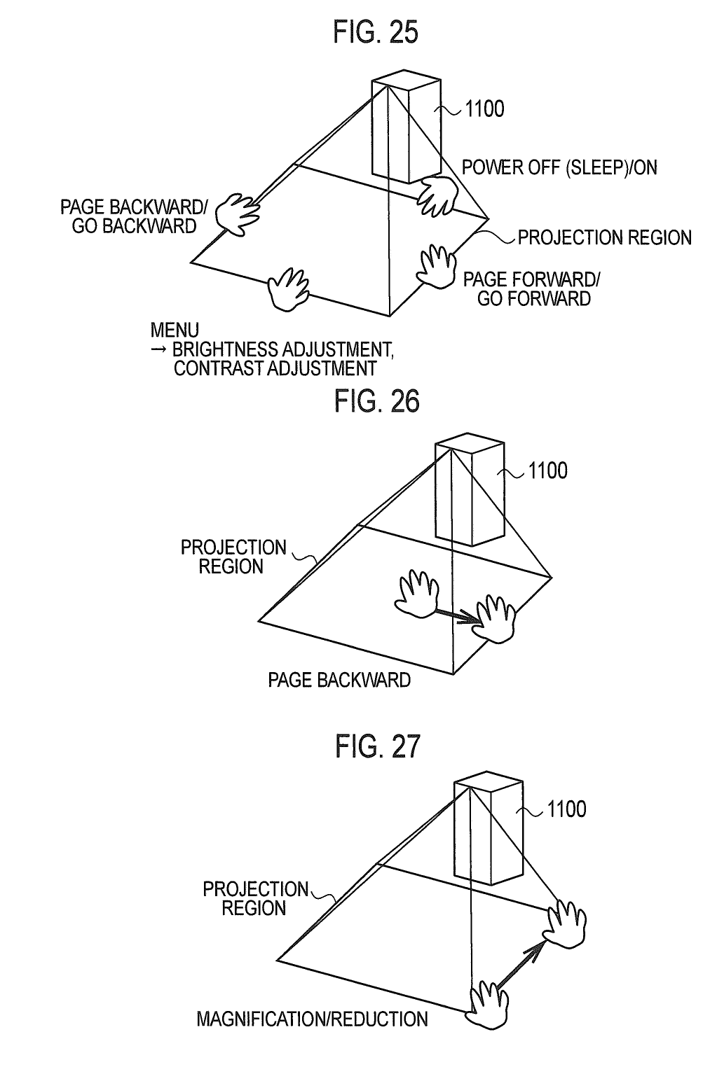

In the following, an execution example of processing detail according to the third embodiment is described with reference to the drawings. FIGS. 24 and 25 are diagrams for explaining an execution example of processing detail according to the third embodiment.

First, the case where the specific regions are provided at 4 corners of the projection region is described with reference to FIG. 24. As shown in FIG. 24, 4 specific regions provided at 4 corners of the projection region are associated with processing details that are different from each other.

Second, the case where the specific regions are provided at 4 sides of the projection region is described with reference to FIG. 25. As shown in FIG. 25, 4 specific regions provided at 4 sides of the projection region are associated with processing details that are different from each other.

### (Operations and Effects)

In the third embodiment, when an object blocking light is detected for a predetermined time period or longer in a specific region, the instruction unit 1330 instructs the execution of the processing detail associated with the specific region. Thus, a user's instruction (interactive operation) can be easily implemented without needing an image capturing device having a high image capture resolution.

That is to say, the processing detail associated with a specific region is executed according to a clearly identifiable trigger, i.e., “an object blocking light is detected for a predetermined time period or longer in the specific region”, thus the processing detail can be identified even with an image capturing device having a lower image capture resolution.

Especially, in the case where the specific region is the boundary region between the inside and the outside of the projection region (for example, 4 sides of the projection region, 4 corners of the projection region), an object blocking light can be easily detected in the specific region. This is because a large brightness (especially, luminance value) difference is made between the inside of the projection region illuminated by the projection light and the outside of the projection region not illuminated by the projection light, thus an object can be easily identified even with an image capturing device having a lower image capture resolution. Consequently, processing detail can be easily identified.

### [Modification 1]

In the following, Modification 1 of the third embodiment is described with reference to the drawings. In the following, the difference between the third embodiment and Modification 1 is mainly described.

In Modification 1, the storage unit 1310 stores the information which associates a moving pattern of light in the specific region with processing detail.

Here, the moving pattern is a pattern which shows a temporal change of the position (object position) of an object blocking light in the specific region. The moving pattern includes, for example, a pattern of linear movement of an object position in a predetermined direction, and a pattern of movement of an object position along a predetermined shape.

When a moving pattern of an object blocking light is detected in the specific region, the instruction unit 1330 instructs the execution of the processing detail associated with the moving pattern.

It should be noted that a certain time is needed to detect a moving pattern because the moving pattern shows a temporal change of an object position. Accordingly, also in Modification 1, similarly to the third embodiment, when an object blocking light is detected for a predetermined time period or longer in a specific region, the instruction unit 1330 instructs the execution of the processing detail associated with the specific region.

### (Execution Example of Processing Detail)

In the following, an execution example of processing detail according to the third embodiment is described with reference to the drawings. FIGS. 26 to 29 are diagrams for explaining execution examples of processing detail according to the third embodiment.

For example, as shown in FIG. 26, the processing detail of “Page Forward” is associated with a pattern of linear movement of an object position in a predetermined direction in a specific region. In FIG. 26, the specific region is, for example, the entire projection region.

Or as shown in FIG. 27, the processing detail of “Magnification/Reduction” is associated with a pattern of linear movement of an object position in a predetermined direction in the specific region. In FIG. 27, the specific region is, for example, a side of the projection region.

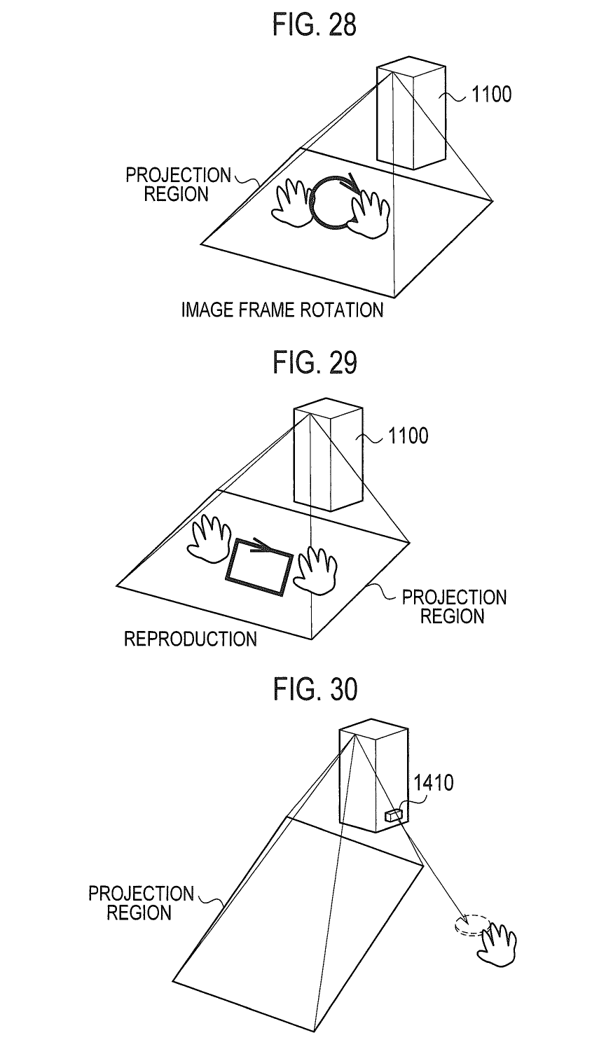

Otherwise, as shown in FIG. 28, the processing detail of “Image rotation” is associated with a pattern of circular movement of an object position in the specific region. In FIG. 28, the specific region is, for example, the entire projection region.

Otherwise, as shown in FIG. 29, the processing detail of “Reproduction” is associated with a pattern of rectangular movement of an object position in the specific region. In FIG. 29, the specific region is, for example, the entire projection region.

### (Operations and Effects)

In Modification 1, when a moving pattern of an object blocking light is detected in the specific region, the instruction unit 1330 instructs the execution of the processing detail associated with the moving pattern. Accordingly, the types of processing details that may be instructed by the instruction unit 1330 can be easily increased.

### [Modification 2]

In the following, Modification 2 of the third embodiment is described with reference to the drawings. In the following, the difference between the third embodiment and Modification 2 is mainly described.

In Modification 2, the projection display apparatus 1100 has a specific light source 1410 which emits specific light to a specific region as shown in FIG. 30. Also, the specific region is provided outside the projection region where the light emitted from the projection display apparatus 1100 is projected.

The specific light source 1410 is a separate body from the light source 1010 which forms an image to be projected on the projection region. The specific light source 1410 may be provided, for example, in an upper portion of the projection display apparatus 1100, or may be provided in a lower portion of the projection display apparatus 1100. Note that FIG. 30 shows the case where the specific light source 1410 is provided in a lower portion of the projection display apparatus 1100.

In a specific region provided outside the projection region, the above-described detection unit 1320 detects an object blocking the light emitted from the specific light source 1410. Similarly to the third embodiment, the detection unit 1320 may be an image capturing device, or may be an illuminance sensor.

In the case where the specific light source 1410 is configured to emit infrared light, the detection unit 1320 may be an infrared sensor.

### (Operations and Effects)

In Modification 2, the detection unit 1320 detects an object blocking the light emitted from the specific light source 1410 in a specific region provided outside the projection region. Accordingly, the detection accuracy for an object blocking light in a specific region is improved. Furthermore, an instruction error for processing detail by the instruction unit 1330 can be avoided.

### [Modification 3]

In the following, Modification 3 of the third embodiment is described with reference to the drawings. In the following, the difference between the third embodiment and Modification 3 is mainly described.

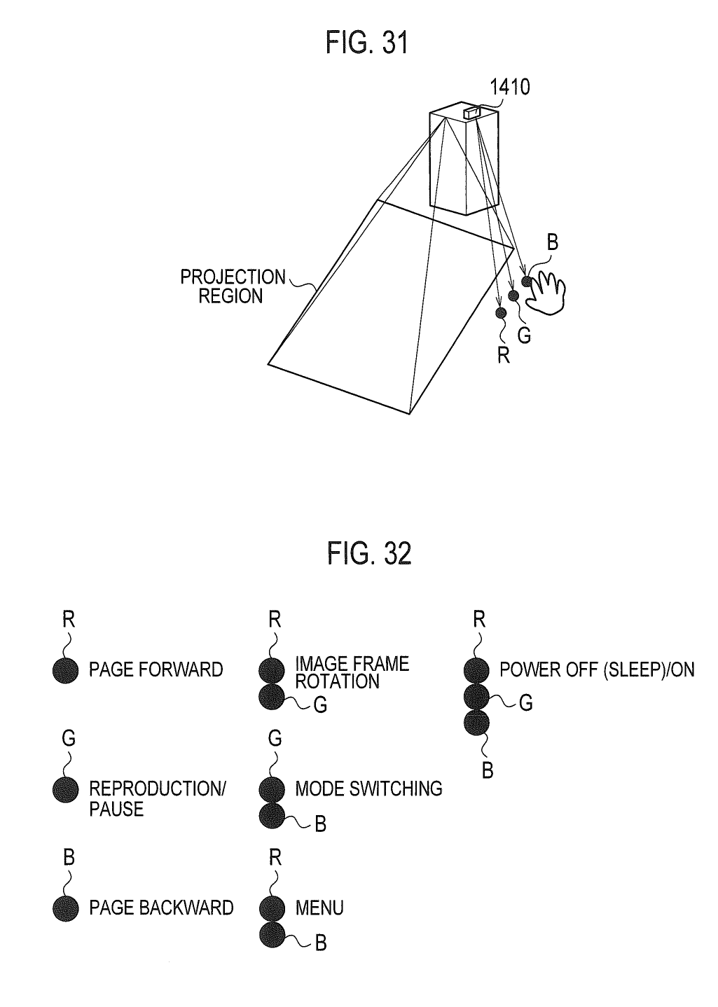

Specifically, in Modification 3, the projection display apparatus 1100 has the specific light source 1410 which emits specific light to a specific region as shown in FIG. 31. Also, the specific region is provided outside the projection region where the light emitted from the projection display apparatus 1100 is projected (similar to Modification 2).

The specific light source 1410 emits multiple types of specific light. Here, “multiple types” may mean that colors of the specific light are different, or may mean that positions on which the specific light is projected are different.

For example, the specific light source 1410 may include a red light emitting device which emits a red light R, a green light emitting device which emits a green light G, and a blue light emitting device which emits a blue light B. Otherwise, the specific light source 1410 may include multiple light emitting devices which emit the same specific light to separate specific regions. Otherwise, the specific light source 1410 may emit light to multiple positions via a diffraction device by providing the diffraction device on the optical path of the light emitted from the specific light source 1410.

FIG. 31 illustrates a case where the specific light source 1410 emits the red light R, the green light G, and the blue light B to separate specific regions. Also, a case where the specific light source 1410 is provided in the upper portion of the projection display apparatus 1100 is illustrated.

The above-described storage unit 1310 stores information which associates a processing detail with a combination of one or more specific light out of multiple types of specific light, which may be blocked in a specific region.

The above-described detection unit 1320 detects an individual object blocking light corresponding one of multiple types of specific light emitted from the specific light source 1410. The detection unit 1320 is preferably an image capturing device. In the case where multiple types of specific light are emitted to separate specific regions, the detection units 1320 may be multiple illuminance sensors which detect an object blocking light in each specific region.

The above-described instruction unit 1330 instructs the execution of the processing detail associated with a combination of the specific light, which is blocked by an object in a specific region. It should be noted that particularly, the instruction unit 1330 instructs the execution of the processing detail associated with a combination of the specific light which is blocked by an object for a predetermined time period or longer in the specific region.

### (Execution Example of Processing Detail)

In the following, an execution example of processing detail according to the third embodiment is described with reference to the drawings. FIG. 32 is a diagram for explaining execution examples of processing detail according to the third embodiment.

As shown in FIG. 32, a combination of one or more specific light (7 patterns) out of the red light R, the green light G, and the blue light B, which may be blocked in a specific region are associated with respective processing details (7 types).

For example, “Page Forward” is associated with the combination in which only the red light R is blocked by an object. “Reproduction/Pause” is associated with the combination in which only the green light G is blocked by an object. “Page Backward” is associated with the combination in which only the blue light B is blocked by an object. Or “Power Supply ON/OFF” is associated with the combination in which all of the red light R, the green light G, and the blue light B are blocked by an object.

### (Operations and Effects)

In Modification 3, the instruction unit 1330 instructs the execution of the processing detail associated with a combination of the specific light, which is blocked by an object in a specific region. Accordingly, the types of processing details that may be instructed by the instruction unit 1330 can be easily increased.

### Other Embodiments

Although the present invention has been described in conjunction with the above embodiments, it should be understood that the invention is not limited by the description and the drawings which form a part of this disclosure. From the disclosure, various alternative embodiments, application examples, application techniques will become apparent to those skilled in the art.

In the embodiments, a DMD (Digital Micromirror Device) has only been illustrated as an imager. The imager may be a reflective liquid crystal panel.

In the above-described embodiments, primarily, cases where multiple types of processing details are feasible have only been illustrated. Specifically, only one type of processing detail may be feasible.

### Overview of Fourth Embodiment

A forth embodiment of a projection display apparatus includes an imager configured to modulate light emitted from a light source; and a projection optics configured to project light emitted from the imager onto a projection plane provided on a horizontal plane. The projection display apparatus includes a device controller configured to control the imager in such a manner that at least a first image frame and a second image frame are displayed on the projection region. The device controller is configured to be able to change orientations of the first image frame and the second image frame.

According to the forth embodiment, the device controller is configured to be able to change the orientations of the first image frame and the second image frame. Accordingly, in the case where it is assumed that users view images from various directions, for example when the images are displayed on the projection plane provided on a horizontal plane such as a surface of a desk, convenience of users is improved.

### Fourth Embodiment

### Schematic Configuration of Projection Display Apparatus

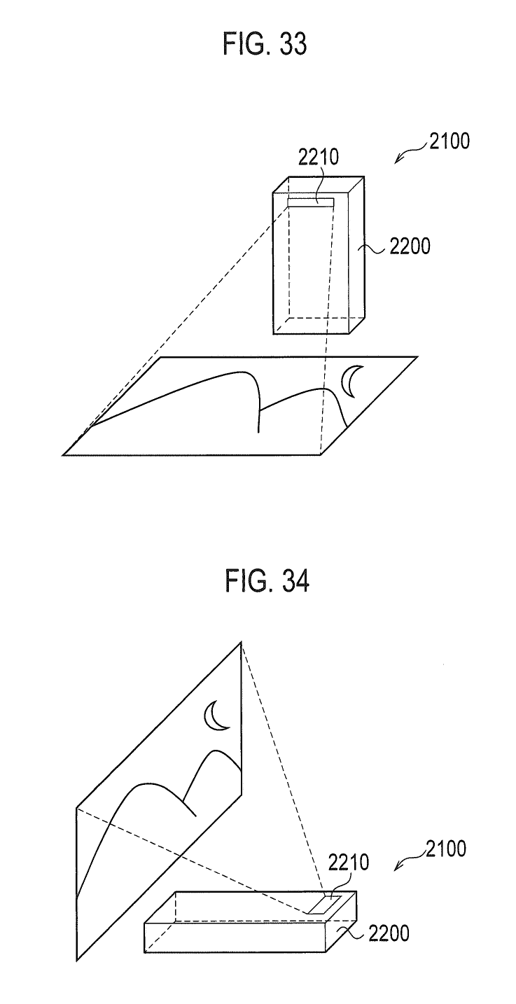

In the following, the schematic configuration of the projection display apparatus according to the fourth embodiment is described with reference to the drawings. FIG. 33 is a diagram showing a projection display apparatus 2100 (floor surface projection) according to the fourth embodiment. FIG. 34 is a diagram showing the projection display apparatus 2100 (wall surface projection) according to the fourth embodiment.

As shown in FIGS. 33 and 34, the projection display apparatus 2100 has a housing 2200 and projects an image onto a projection plane (not shown). The housing 2200 is provided with a transmissive region 2210 through which the light emitted from a later-described projection optics 2110 transmits.

The projection plane may be provided on a horizontal plane such as a floor surface or a surface of a desk as shown in FIG. 33, or may be provided on a vertical plane such as a wall surface (for example, a screen) as shown in FIG. 34. That is to say, the projection display apparatus 2100 may be arranged in such a manner as to project image light onto a horizontal plane such as a floor surface or a surface of a desk, or may be arranged in such a manner as to project image light onto a vertical plane such as a wall surface.

The size of the projection display apparatus 2100 is an approximately PET bottle size having a capacity of 200 ml to 2 l. For example, the capacity of the projection display apparatus 2100 is approximately 900 ml, and the weight of the projection display apparatus 2100 is approximately 800 g. The size of an image displayed by the projection display apparatus 2100 is, for example, approximately 20 inches. It should be noted that the distance between the projection display apparatus 2100 and the projection plane is substantially short.

### (Optical Configuration of Projection Display Apparatus)

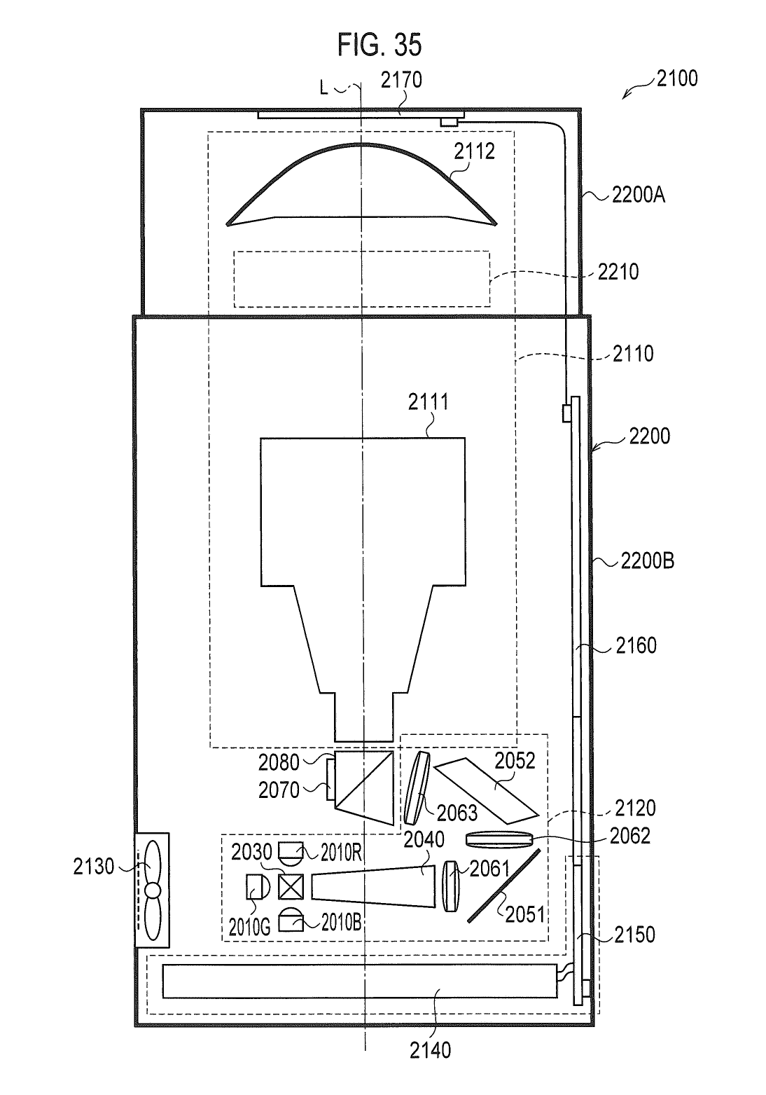

In the following, the optical configuration of the projection display apparatus according to the fourth embodiment is described with reference to the drawings. FIG. 35 is a diagram mainly showing the optical configuration of the projection display apparatus 2100 according to the fourth embodiment.

As shown in FIG. 35, the projection display apparatus 2100 has a projection optics 2110, an illumination optical system 2120, a cooling fan 2130, a battery 2140, a power source substrate 2150, a main control substrate 2160, and an operating substrate 2170. In addition, the projection display apparatus 2100 has a DMD 2070 and a reflection prism 2080.

Also, the housing 2200 includes a first housing 2200A and a second housing 2200B. The above-mentioned transmissive region 2210 is provided in the first housing 2200A. A part or all of the first housing 2200A is configured to be able to be housed in the second housing 2200B as described later.

The projection optics 2110 projects the color component light (image light) emitted from the DMD 2070 onto the projection plane. Specifically, the projection optics 2110 has a projection lens group 2111 and a reflection mirror 2112.

The projection lens group 2111 emits the color component light (image light) emitted from the DMD 2070 to the reflection mirror 2112. The projection lens group 2111 includes a lens in an approximately circular shape centered on the optical axis L of the projection optics 2110, and a lens in the shape defined by a part of an approximately circular shape centered on the optical axis L of the projection optics 2110 (for example, a lower half semicircular shape).

It should be noted that the diameter of a lens included in the projection lens group 1111 is greater as the lens is closer to the reflection mirror 2112.

The reflection mirror 2112 reflects the color component light (image light) emitted from the projection lens group 2111. The reflection mirror 2112, after collecting image light, diverges it. For example, the reflection mirror 2112 is an aspheric mirror which has a concave surface toward the projection lens group 2111. The reflection mirror 2112 has a shape defined by a part of an approximately circular shape centered on the optical axis L of the projection optics 2110 (for example, a lower half semicircular shape).

The image light collected by the reflection mirror 2112 transmits the transmissive region 2210 provided in the housing 2200. The transmissive region 2210 provided in housing 2200 is preferably provided in the vicinity of the location where image light is collected by the reflection mirror 2112.

The illumination optical system 2120 has a light source 2010, a dichroic prism 2030, a rod integrator 2040, a mirror 2051, a mirror 2052, a lens 2061, a lens 2062, and a lens 2063.

The light source 2010 is configured to individually emit color component light of each of multiple colors. Also, the light source 1010 may be provided nearby with a heat sink which radiates heat generated by the light source 1010. The light source 2010 includes, for example, a light source 2010R, a light source 2010G, and a light source 2010B.

The light source 2010R is a light source which emits red component light R, and is, for example, a red LED (Light Emitting Diode), or a red LD (Laser Diode). The light source 2010R may also be provided nearby with a heat sink composed of a member having high heat dissipation such as metal.

The light source 2010G is a light source which emits green component light G, and is, for example, a green LED, or a green LD. The light source 2010G may also be provided nearby with a heat sink composed of a member having high heat dissipation such as metal.

The light source 2010B is a light source which emits blue component light B, and is, for example, a blue LED, or a blue LD. The light source 2010B may also be provided nearby with a heat sink composed of a member having high heat dissipation such as metal.

The dichroic prism 2030 combines the red component light R emitted from the light source 2010R, the green component light G emitted from the light source 2010G, and the blue component light B emitted from the light source 2010B.

The rod integrator 2040 has a light incidence surface, a light emitting surface, and a light reflective lateral surface provided across from the circumference of the light incidence surface to the circumference of the light emitting surface. The rod integrator 2040 equalizes the color component light emitted from the dichroic prism 2030. Particularly, the rod integrator 2040 equalizes the color component light by reflecting it on the light reflective lateral surface. The rod integrator 2040 may be a solid rod composed of glass, or a hollow rod whose inner surface is formed of mirror surfaces.

For example, in the fourth embodiment, the rod integrator 2040 has a tapered shape with a greater cross-section along and perpendicular to the traveling direction of the light emitted from the light source 2010. However, the embodiment is not limited to this case. The rod integrator 2040 may have a reverse-tapered shape with a smaller cross-section along and perpendicular to the traveling direction of the light emitted from the light source 2010.

The mirror 2051 and mirror 2052 are reflection mirrors for bending an optical path in order to guide the light emitted from the rod integrator 2040 to the DMD 2070.

The lens 2061, lens 2062, and lens 2063 are relay lenses which form an image of the color component light emitted from the light source 2010 nearly on the DMD 1070, while suppressing the divergence of the color component light.

The cooling fan 2130 communicates with the outside of the housing 2200 and is configured to release the heat in the housing 2200. Alternatively, the cooling fan 2130 is configured to send the air outside of the housing 2200 into it. For example, the cooling fan 2130 is provided in the vicinity of the light source 2010, and is configured to cool the light source 2010.

The battery 2140 stores electric power to be supplied to the projection display apparatus 2100.

The power source substrate 2150 is connected to the battery 2140, and has a power inverter circuit which converts AC power to DC power.

The main control substrate 2160 has a main control circuit (a later-described control unit 2300) configured to control the operation of the projection display apparatus 2100.

The operating substrate 2170 is connected to an operating unit (such as a button) provided in the projection display apparatus 2100, and an operating signal inputted from the operating unit is sent to the main control substrate 2160 (main control circuit).

The DMD 2070 is formed of multiple micro mirrors, which are movable. Each micro mirror basically corresponds to one pixel. The DMD 2070 enables or disables the reflection of the color component light by changing the angle of each micro mirror so that the color component light is guided to the projection optics 2110 as effective light.

The reflection prism 2080 transmits the light emitted from the illumination optical system 2120 to the DMD 2070. On the other hand, the reflection prism 2080 reflects the light emitted from the DMD 2070 to the projection optics 2110.

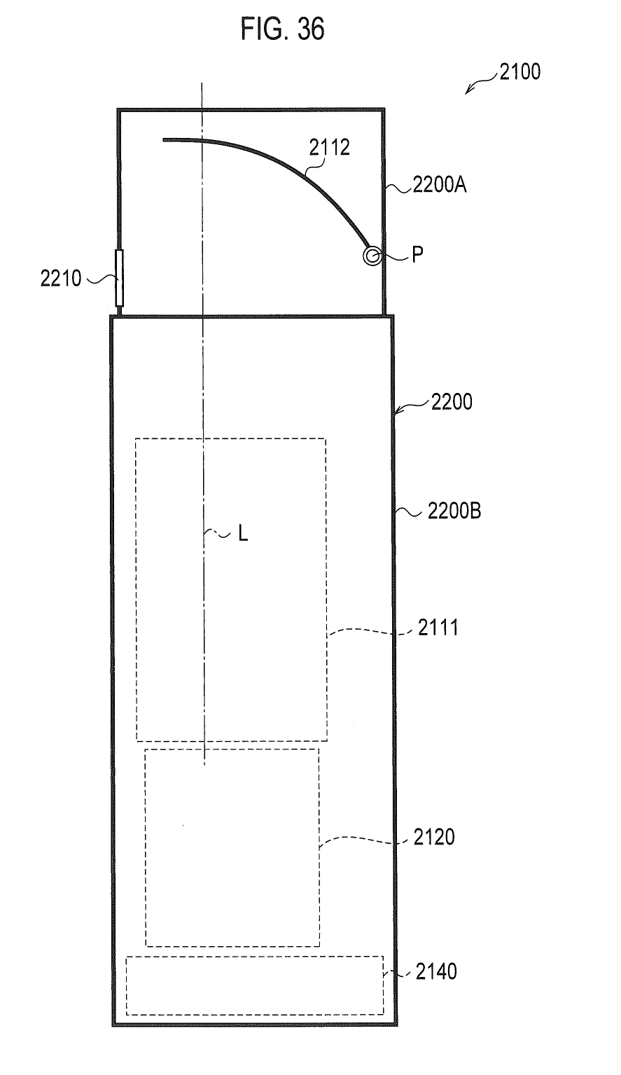

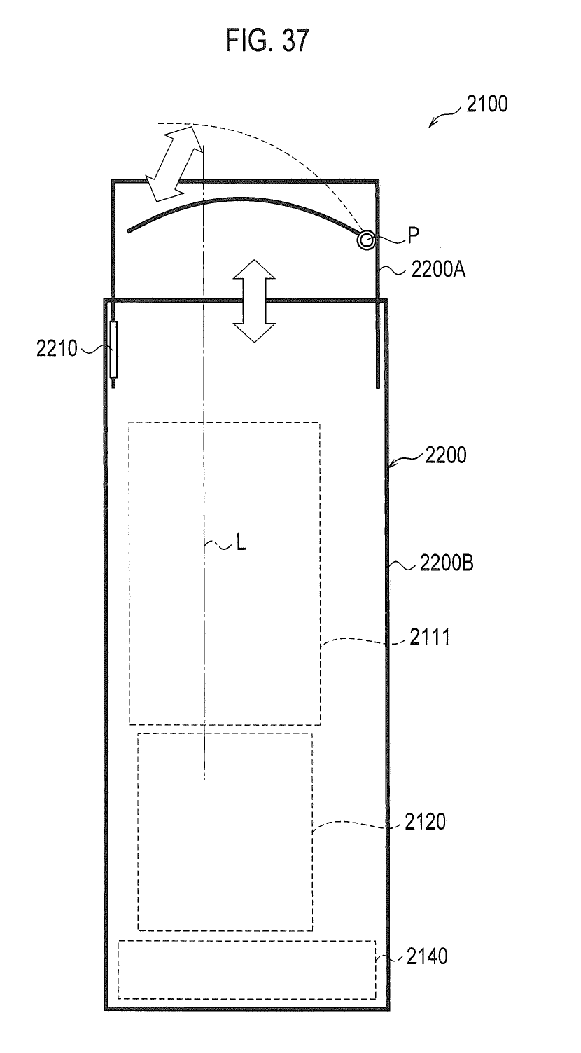

As shown in FIGS. 36 and 37, the first housing 2200A is configured to be able to be slid into the second housing 2200B along the inner wall thereof. The reflection mirror 2112 is rotated about the rotation axis P in conjunction with sliding of the first housing 2200A.

### (Configuration of Control Unit)

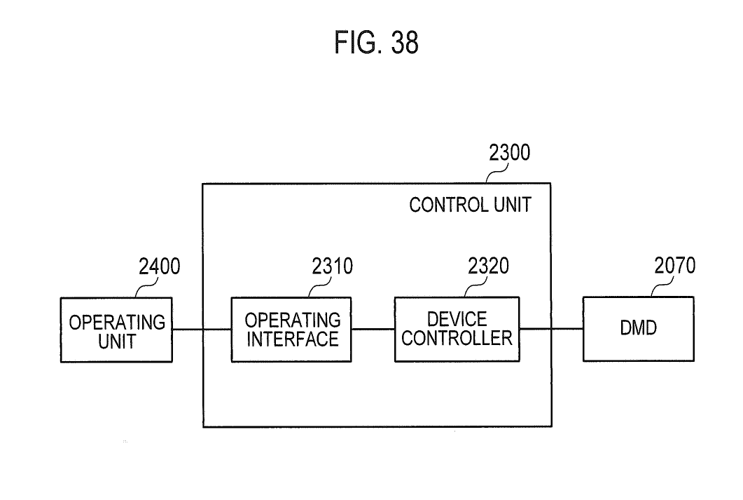

In the following, the control unit according to the fourth embodiment is described with reference to the drawings. FIG. 38 is a block diagram showing a control unit 2300 according to the fourth embodiment. The control unit 2300 is provided in the projection display apparatus 2100, and controls the projection display apparatus 2100.

As shown in FIG. 38, the control unit 2300 has an operating interface 2310, and a device controller 2320.

The control unit 2300 converts an image input signal to an image output signal. The image input signal includes a red input signal Rᵢₙ, a green input signal Gᵢₙ, and a blue input signal Bᵢₙ. The image output signal includes a red output signal Rₒᵤₜ, a green output signal Gₒᵤₜ, and a blue output signal Bₒᵤₜ. The image input signal and the image output signal are signals which are inputted for each of multiple pixels includes in 1 frame.

The operating interface 2310 is connected to an operating unit 2400, and acquires an operating signal from the operating unit 2400. The operating unit 2400 has a power switch or the like for switching ON/OFF of the power supply of the projection display apparatus 2100. Or the operating unit 2400 may also include e.g., a cross button. For example, the cross button is used to identify the operator of the projection display apparatus 2100. Particularly, the operator is identified by turning the power switch ON while designating with the cross button the direction indicating the position of the operator of the projection display apparatus 2100.

The device control unit 2320 converts an image input signal to an image output signal, and controls the DMD 2070 based on the image output signal.

In the fourth embodiment, the device controller 2320 controls the DMD 2070 in such a manner that at least the first and second image frames are displayed on the projection region. Also, the device controller 2320 is configured to be able to change the orientation of the first and second image frames. The first and second image frames are the images frames on which the images to be viewed by users are displayed. Also, the first image frame may be an image frame on which the images to be viewed by viewers other than the operator of the projection display apparatus 2100 are displayed. The second image frame may be an image frame on which images to be viewed by the operator of the projection display apparatus 2100 are displayed.

When the images to be viewed by the operator of the projection display apparatus 2100 are displayed, the device controller 2320 may control the DMD 2070 in such a manner that the first and second image frames are displayed on the projection region.

First, the device controller 2320 may control the DMD 2070 in such a manner as to display the image selected on the second image frame, on the first image frame in synchronization with the image selected on the second image frame, while displaying the first and second image frames on the projection region simultaneously.

Second, the device controller 2320 may control the DMD 2070 in such a manner as to switch the second image frame to the first image frame and display the image selected on the second image frame, on the first image frame.

Third, the device controller 2320 may control the DMD 2070 in such a manner as to display the list of the images stored in an external storage medium on the second image frame in the case where the external storage medium is connected to the projection display apparatus 2100 when it is turned on.

The external storage medium includes a memory medium configured with a non-volatile memory such as a flash memory, a personal computer, and a hard disk. Also, the list of the images may be thumbnails of the images, or may be a list of names of the images.

Fourth, when the power supply of the projection display apparatus 2100 is turned on using an operation (the power switch and cross key) of the operating unit 2400, the device controller 2320 may control the orientation of the second image frame according to the operator's position identified by the operation of the operating unit 2400.

Fifth, when the power supply of the projection display apparatus 2100 is turned off and then turned on, the device controller 2320 may control the DMD 2070 in such a manner as to display the image as the power supply is turned on, in the position of the image being displayed when the power supply is turned off.

### Display Example of First Image Frame and Second Image Frame

In the following, display examples of the first image frame and the second image frame according to the fourth embodiment are described with reference to the drawings.

### First Display Example

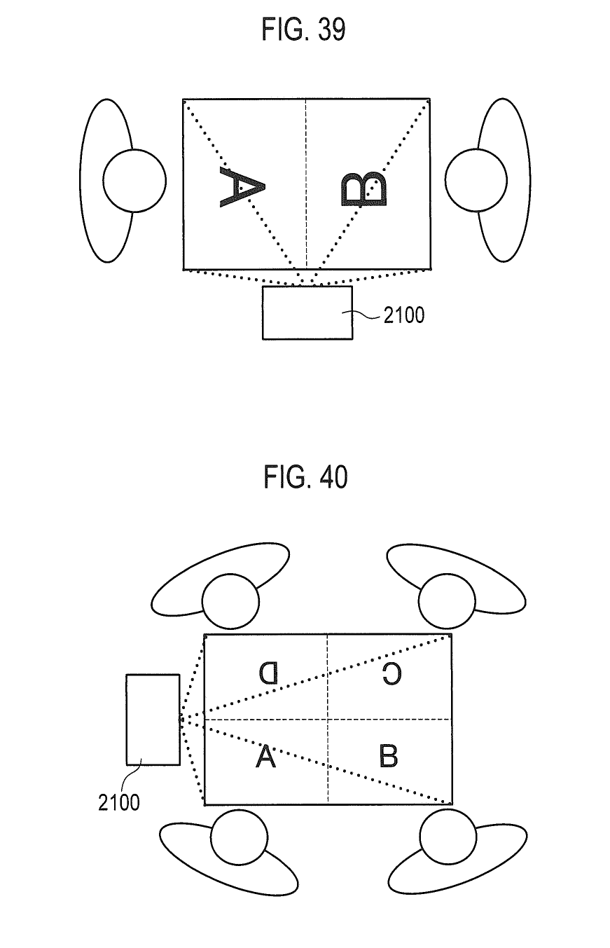

In the first display example, there is no difference between an operator and viewers. For example, as shown in FIG. 39, two image frames may be displayed in different orientations. Alternatively, as shown in FIG. 40, four image frames may be displayed in different orientations.

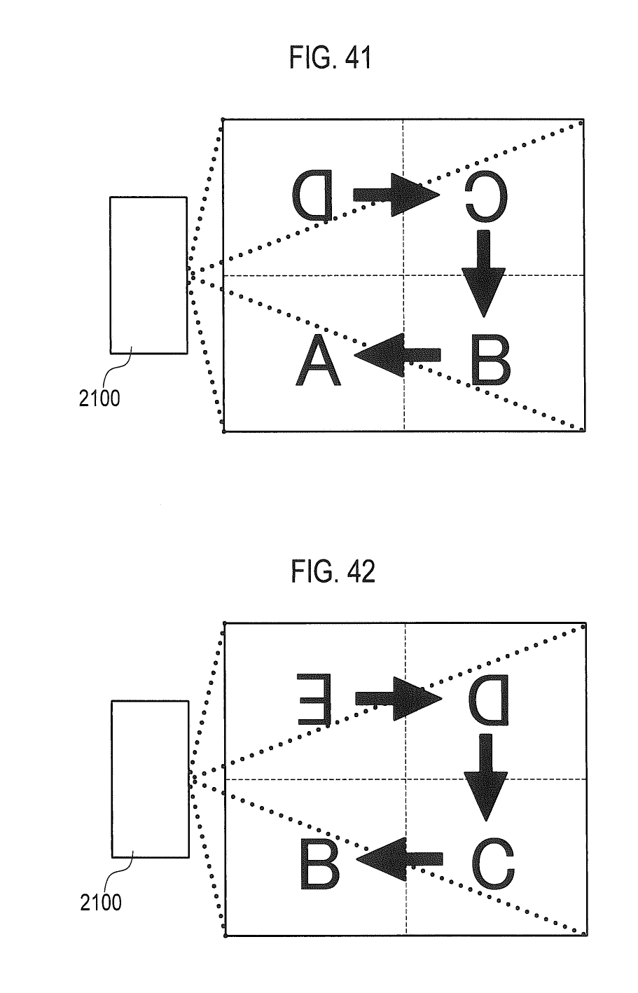

The case where four image frames are displayed in different orientations as shown in FIG. 40 and all users view image A, image B, image C, image D, and image E is considered. In such a case, the projection display apparatus 2100 may be configured to circulate the images while changing the orientations thereof so that all users can view the images A to E in an appropriate orientation. For example, the case where the image E is displayed and the image A is not displayed as shown in FIG. 42 after the images A to D are displayed as shown in FIG. 41 is illustrated. In such a case, the projection display apparatus 2100 displays the image E, while switching the image frames on which the images B to D are displayed, and changing the orientation of the image C.

### Second Display Example

In the second display example, the first image frame is an image frame on which the image to be viewed by the viewers except the operator is displayed, and the second image frame is an image frame on which the image to be viewed by the operator is displayed.

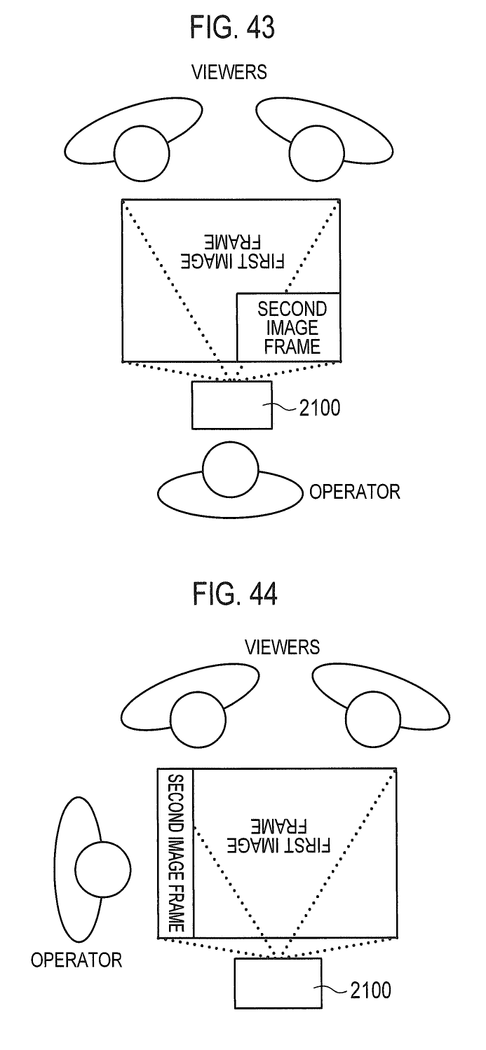

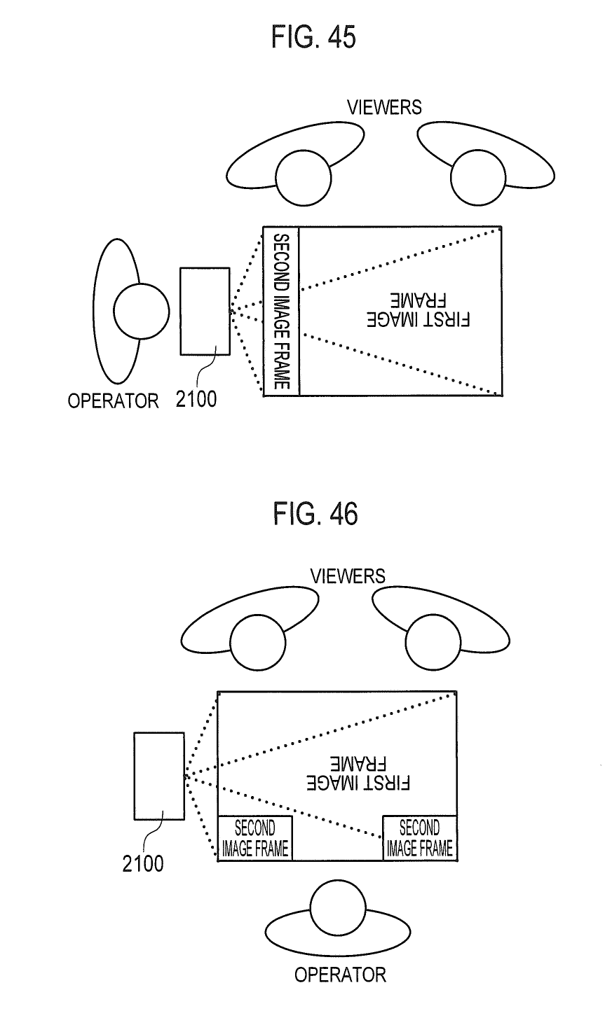

Specifically, as shown in FIGS. 43 to 45, an image is displayed on the first image frame according to the positions of the viewers, and another image is displayed according to the position of the operator. Although examples of combinations of orientations of the first image frame and the second image frame is shown in FIGS. 43 to 45, the first and the second image frames may be displayed in a combination other than these combinations. Alternatively, as shown in FIG. 46, the second image frame may be divided and displayed in multiple regions.

In the case where the orientation of the second image frame is controlled based on the operator's position, as shown in FIGS. 43 to 46, the second image frame is displayed in an orientation to be viewed by the operator, for example. As described above, for example when the power supply of the projection display apparatus 2100 is turned on using an operation (the power switch and cross key) of the operating unit 2400, the operator's position is identified by the operation of the operating unit 2400.

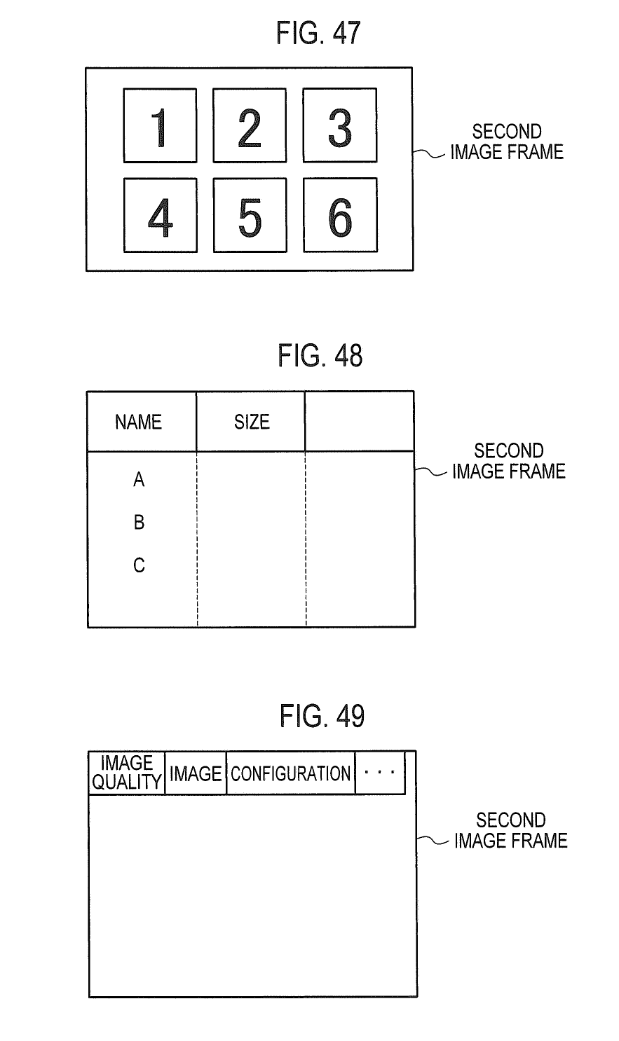

Alternatively, the thumbnails of the images may be displayed on the second image frame as shown in FIG. 47. Otherwise, the names of images and a list of attributes may be displayed on the second image frame as shown in FIG. 48. Otherwise, as shown in FIG. 49, a list of operation menu (such as “image quality,” “image,” and “configuration”) for the projection display apparatus 2100 may be displayed on the second image frame.

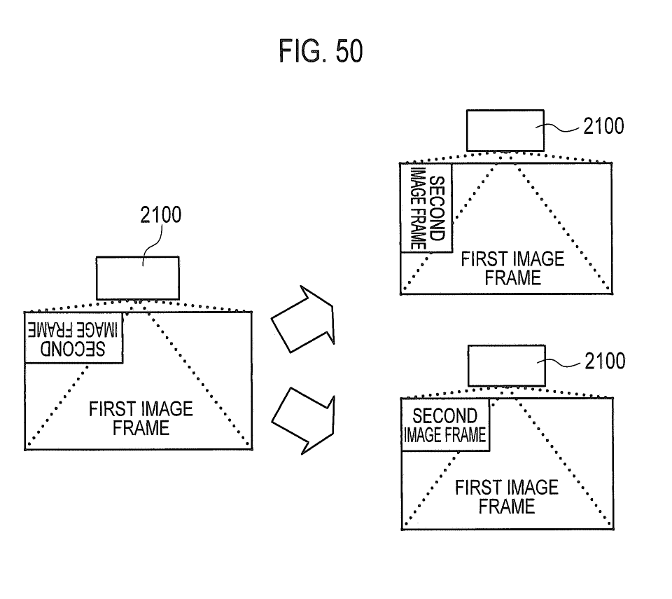

Furthermore, as shown in FIG. 50, the configuration may be made such that the position and orientation of the second image frame on the projection plane can be switched by an operation of the operating unit 2400. Also, the configuration may be made such that the size of the second image frame on the projection plane can be switched by an operation of the operating unit 2400.

### Third Display Example

In the third display example, the first image frame is an image frame on which the image to be viewed by the viewers except the operator is displayed, and the second image frame is an image frame on which the image to be viewed by the operator is displayed.

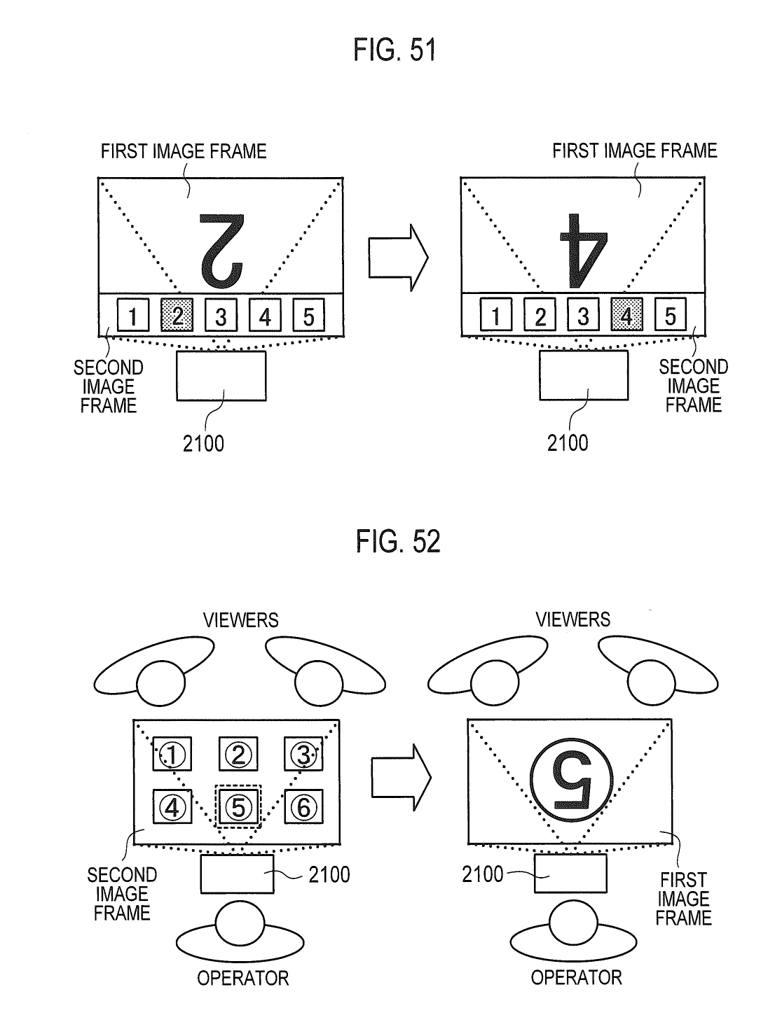

As shown in FIG. 51, the first image frame and the second image frame are simultaneously displayed on the projection plane. Also, multiple candidate images are displayed on the second image frame. On the first image frame, the candidate image selected on the second image frame is displayed in synchronization with the candidate image.

For example, as shown in FIG. 51, when an image “2” is selected on the second image frame, the image “2” is displayed on the first image frame in synchronization with the image “2.” Similarly, when an image “4” is selected on the second image frame, the image “4” is displayed on the first image frame in synchronization with the image “4.”

### Fourth Display Example

In the fourth display example, the first image frame is an image frame on which the image to be viewed by the viewers except the operator is displayed, and the second image frame is an image frame on which the image to be viewed by the operator is displayed.

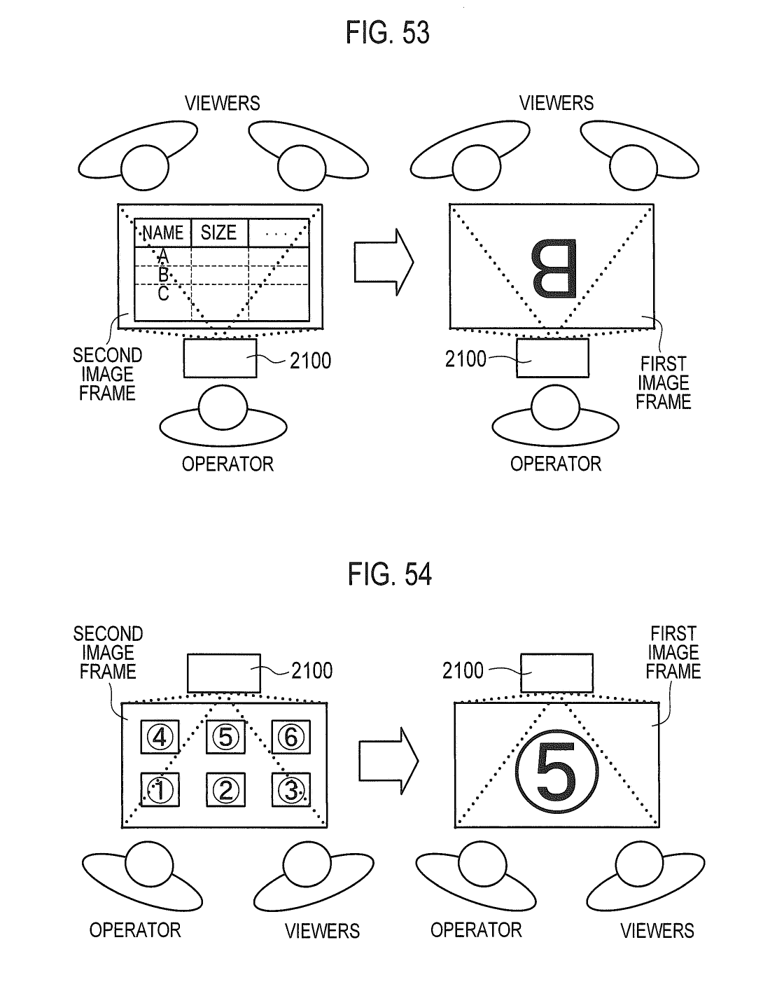

As shown in FIGS. 52 and 53, the first image frame and the second image frame are separately displayed on the projection plane asynchronously. Also, multiple candidate images are displayed on the second image frame. When an image is selected on the second image frame, the second image frame is switched to the first image frame and the image selected on the second image frame is displayed on the first image frame.

For example, when an image “5” is selected from the thumbnails of the images on the second image frame as shown in FIG. 52, the second image frame is switched to the first image frame and the image “5” selected on the second image frame is displayed on the first image frame.

Alternatively, as shown in FIG. 53, when the image “B” is selected from the names of images or a list of attributes on the second image frame, the second image frame is switched to the first image frame and the image “B” selected on the second image frame is displayed on the first image frame.

Also, the configuration may be made such that the orientation of the first image frame can be switched by an operation of the operating unit 2400. For example, as shown in FIG. 54, when the operator and viewers are on the same side on the projection plane, the first image frame and the second image frame may be displayed in the same orientation.

### (Operations and Effects)

In the fourth embodiment, the device controller 2320 is configured to be able to change the orientations of the first image frame and the second image frame. Accordingly, in the case where it is assumed that users view images from various directions, for example when the images are displayed on the projection plane provided on a horizontal plane such as a surface of a desk, convenience of users is improved.

### Other Embodiments

Although the present invention has been described in conjunction with the above embodiments, it should be understood that the invention is not limited by the description and the drawings which form a part of this disclosure. From the disclosure, various alternative embodiments, application examples, application techniques will become apparent to those skilled in the art.

In the embodiments, a DMD (Digital Micromirror Device) has only been illustrated as an imager. The imager may be a reflective liquid crystal panel.

What is claimed is:

1. A projection display apparatus for projecting an image light onto a projection plane, comprising:
a detector configured to detect a state of the projection display apparatus with respect to the projection plane; and
a controller configured to control a state of the image light according to the detected state.

2. The projection display apparatus according to claim 1,
wherein the detector is an installation surface detector configured to detect an installation state of the projection display apparatus; and
the controller controls a direction of the image light according to the installation state.

3. The projection display apparatus according to claim 2,
wherein the detector detects a first mode in which an approximately horizontal plane is the projection plane, and a second mode in which an approximately vertical plane is the projection plane; and
the controller reverses the image light upside down according to the first mode and the second mode.

4. The projection display apparatus according to claim 2,
wherein the detector detects a first mode in which an approximately horizontal plane is the projection plane, and a second mode in which an approximately vertical plane is the projection plane; and
the controller controls an aspect ratio of the image light according to the first mode and the second mode.

5. The projection display apparatus according to claim 1,
wherein the detector is a projection distance detector configured to detect a projection distance from the projection display apparatus; and
the controller controls a brightness of the image light according to the projection distance.

6. A projection display apparatus including an imager configured to modulate light emitted from a light source; and a projection optics configured to project light emitted from the imager onto a projection plane,
the projection display apparatus comprising:
a storage unit configured to store information which associates a specific region provided on the projection plane with processing detail to be performed by the projection display apparatus;
a detection unit configured to detect an object blocking light in the specific region; and
an instruction unit configured to instruct an execution of the processing detail associated with the specific region when an object blocking light is detected for a predetermined time period or longer in the specific region.

7. The projection display apparatus according to claim 6,
wherein the specific region is a boundary region between an inside and an outside of a projection region where light emitted from the projection optics is projected.

8. The projection display apparatus according to claim 6,
wherein the storage unit stores information which associates a moving pattern of an object blocking light in the specific region with the processing detail; and
when an object blocking light is detected with the moving pattern in the specific region, the instruction unit instructs an execution of the processing detail associated with the moving pattern.

9. The projection display apparatus according to claim 6 further comprising a specific light source configured to emit specific light to the specific region,
wherein the specific region is provided outside a projection region where light emitted from the projection optics is projected; and
the detection unit detects an object blocking light emitted from the specific light source in the specific region.

10. The projection display apparatus according to claim 8,
wherein the specific light source is configured to emit a plurality of types of specific light;
the storage unit stores information which associates the processing detail with a combination of one or more types of specific light which is possibly blocked by the object in the specific region out of the plurality of types of specific light; and
the instruction unit instructs an execution of the processing detail associated with a combination of the one or more types of specific light which is blocked by the object in the specific region.

11. A projection display apparatus including an imager configured to modulate light emitted from a light source; and a projection optics configured to project light emitted from the imager onto a projection plane provided on a horizontal plane,
the projection display apparatus comprising a device controller configured to control the imager in such a manner that at least a first image frame and a second image frame are displayed on the projection region, wherein
the device controller is configured to be able to change orientations of the first image frame and the second image frame.

12. The projection display apparatus according to claim 11,
wherein the second image frame is an image frame on which an image to be viewed by an operator of the projection display apparatus is displayed.

13. The projection display apparatus according to claim 12,
wherein the device controller controls the imager in such a manner as to display an image, which is selected on the second image frame, on the first image frame in synchronization the image selected on the second image frame.

14. The projection display apparatus according to claim 12,
wherein the device controller controls the imager in such a manner as to switch the second image frame to the first image frame and display an image selected on the second image frame, on the first image frame.

15. The projection display apparatus according to claim 12,
wherein the device controller controls the imager in such a manner as to display a list of images stored in an external storage medium, on the second image frame in a case where the external storage medium is connected to the projection display apparatus when the projection display apparatus is turned on.

16. The projection display apparatus according to claim 12, further comprising a power switch configured to be able to identify a position of an operator of the projection display apparatus,
wherein the device controller controls orientation of an image displayed on the second image frame according to the position of the operator identified by the power switch.

17. The projection display apparatus according to claim 11,
wherein when a power supply of the projection display apparatus is turned off and then turned on, the device controller controls the imager in such a manner as to display an image as the power supply is turned on, in a position of the image being displayed when the power supply is turned off.
